(19) United States
(12) Patent Application Publication
(10) Pub. No.: US 2023/0233997 A1
(43) Pub. Date: Jul. 27, 2023

(54) CONTROLLABLE LIQUID TRANSPORT MATERIAL, SYSTEM, AND METHOD FOR PREPARING THEREOF

(71) Applicant: THE HONG KONG POLYTECHNIC UNIVERSITY, Hong Kong (CN)

(72) Inventors: Dahua SHOU, Hong Kong (CN); Jintu FAN, Hong Kong (CN); Yuheng GU, Hong Kong (CN); Chao ZOU, Hong Kong (CN)

(21) Appl. No.: 18/000,689

(22) PCT Filed: Jun. 7, 2021
(86) PCT No.: PCT/CN2021/098554

§ 371 Date: Dec. 5, 2022

Related U.S. Application Data
(60) Provisional application No. 62/705,049, filed on Jun. 9, 2020.

(51) Int. Cl. B01D 61/42; B32B 5/02; B32B 7/12; B32B 5/26; B01D 69/02; A41D 31/10; D03D 15/50; D04B 1/16; D04B 21/00; D06M 14/04; D06M 23/16; D06M 14/22; D06M 10/02; D06M 11/46; D06M 15/356; D06M 15/63

(52) U.S. Cl. CPC B01D 61/42; A41D 31/10; B01D 69/02; B32B 5/022; B32B 5/024; B32B 5/026; B32B 5/26; B32B 7/12; D03D 15/50; D04B 1/16; D04B 21/00; D06M 10/025; D06M 11/46; D06M 14/04; D06M 14/22; D06M 15/63; D06M 15/3566; D06M 23/16; B01D 2325/36; B01D 2325/38; B32B 2250/40; B32B 2255/02; B32B 2255/26; B32B 2262/08; B32B 2262/062; B32B 2262/103; B32B 2262/106; B32B 2262/0246; B32B 2262/0253; B32B 2262/0261; B32B 2262/0276; B32B 2307/73; B32B 2307/728; B32B 2307/7246; B32B 2307/7265; B32B 2437/00; B32B 2535/00; B32B 2571/00; D06M 2101/06; D10B 2401/021; D10B 2401/022

(57) ABSTRACT

Provided herein are a controllable liquid transport material, a controllable liquid transport system and a method for preparing a controllable liquid transport material, where a first region of the controllable liquid transport material is treated to be hydrophobic, while a plurality of second regions partially contacted or completely separated with different shapes are treated to have a gradient or varied wettabilities and/or pore sizes for passively controllable liquid transport, and/or integrated with a smart material for actively controllable liquid transport driven by an external force, allowing efficiently and controllably directional transport of a liquid e.g., sweat. The controllable liquid transport system comprises a controllable liquid transport material used as a liquid transport layer and a breathable, waterproof protective layer.

### CROSS-REFERENCE TO RELATED APPLICATION

This is a 371 application of International Patent Application No. PCT/CN2021/098554 filed June 7^{th}, 2021 claiming priority from the U.S. Provisional Pat. Application No. 62/705,049 filed June 9^{th}, 2020, and the disclosures of which are incorporated herein by reference in its entirety.

### TECHNICAL FIELD

The present invention generally relates to a controllable liquid transport material, a controllable liquid transport system and a method for preparing thereof.

### BACKGROUND

Human beings lower their body temperature through sweating. Evaporation of sweat takes away heat from human body and reduces the skin temperature. However, it is extremely unpleasant to wear wet and soaked clothes or woven fabrics when wearers sweat too much. Saturation of sweat liquid makes clothes or woven fabrics heavy and clingy to the body skin, restricting body movement of the wearer and greatly reducing breathability of the clothes/woven fabrics when the excessive sweat liquid cannot be removed effectively. The wearer may then feel damp and cold after his/her activity stops, leading to an after-chilling effect. Moreover, external liquids penetrating the fabrics and clothes can cause discomfort and even harm to the human body. For example, thermal conductivity of the firefighter uniform increases significantly with an absorption of external liquid, increasing the risk of skin burns. Medical/healthcare staff suffer from discomfort and heat stress caused by heavy perspiration and sweat vapor condensation on the skin under high work tension, which can cause bacterial or viral infection when they try to cool down and gain comfort by stretching their clothes. Though outdoor enthusiasts or athletes often sweat a lot even in a cold environment, with a substantially reduced thermal insulation of wet and saturated clothes/fabrics, they can be at high risk of freezing injury.

Moisture transmissibility of a textile material such as fabric is critical to the wearer’s performance and comfort. However, it is challenging for current moisture management fabrics to remove and transport excessive sweat liquid efficiently. The maximum sweating rate of an adult reaches 2-4 liters per hour or 10-14 liters per day (10-15 g/min·m²) [1-3]. Fabrics made from moisture absorbent natural fibers such as wool and cotton can absorb a small amount of liquid or water vapor from perspiration, keeping the body skin dry under a low rate of perspiration. However, when the wearer is highly active, a significant amount of sweat is generated, making the saturated fabrics heavy and clingy. Besides the discomfort caused by heavy sweating, such fabrics cannot prevent penetration and absorption of external liquids such as rainwater or toxic liquids, which can moisten the skin and endanger the wearer’s health. Since synthetic fibers such as nylon and polyester have a low moisture retention, they are widely used in active-wear and sportswear. These synthetic fabrics allow quick wicking and drying based on capillary evaporation. For example, Coolmax fibers with lengthwise grooves have 20% more surface area than round fibers, increasing the number of evaporation sites for drying and capillary pressure for wicking [4]. However, those fabrics cannot prevent penetration by external liquids. Breathable protective fabrics such as Gore-Tex have been developed to allow water evaporation freely but block the penetration of liquids and resist cold wind, because the fabric pores are between the sizes of liquid and gaseous state water molecules. However, wearers still find it challenging to transport the sweat liquid effectively away from the skin side, as the fabric is waterproof to the fluid of the liquid from either side.

Recently, researchers have developed fabric materials with through-thickness wettability gradients or differences, where liquid tends to flow from the hydrophobic side to the hydrophilic side as a result of differential capillary pressure, and the liquid flow is prevented from the opposite side [5-11]. Dual-layer nanofibrous membranes composed of hydrophobic and hydrophilic layers have also been fabricated, demonstrating similar directional liquid transport properties [12-16]. The directions and rates of liquid flow are both controllable by changing the pore size throughout the fabric thickness [17-23]. However, liquid can still be absorbed by the hydrophilic layer in those fabrics, greatly increasing the weight and reducing the breathability of such fabrics when they are saturated with liquid. Moreover, the transfer of sweat liquid becomes less efficient in such saturated fabrics, because the sweat is removed by evaporation instead of liquid transport. To reduce the clinging effect, hydrophobic fabrics have been treated as spot-like regions with wettability gradient [24]. However, the transport efficiency is constrained by the insufficient contact area with the liquid state of water and gravitational water pressure (water column height).

Therefore, conventional hygroscopic quick-drying fabrics are heavy, sticky, and unbreathable when they are saturated with sweat liquids. They do not allow directional liquid transport and cannot repel external liquids such as rains. Conventional breathable protective fabrics do not allow liquid to transfer, while their liquid transport mechanism by evaporation is inefficient. Other conventional fabrics transport the liquid by passive capillary action, which is sometimes less efficient and uncontrollable as compared to the active driving mechanisms such as low electric voltage and ultrasonic oscillation.

### SUMMARY OF INVENTION

The present invention relates to a controllable liquid transport material (e.g., a textile material, or a fabric), including a first region (e.g., a main region of the material) being treated to be hydrophobic, second region(s) discretely distributed throughout the material with different shapes (e.g., localized region(s) of the material) being treated to have a gradient wettability or varied wettabilities and/or pore sizes for passively controllable liquid transport, and/or integrated with smart materials for actively controllable liquid transport driven by external forces (e.g., electroosmotic force or ultrasonic oscillation), thereby allowing efficiently and controllably directional transport of sweats, blocking external liquids, reducing cling, and keeping the material breathable and dry.

The present invention provides a controllable liquid transport material (e.g., a textile material, or a fabric) controlling direction and speed of liquid transport through the material. The present invention also provides methods for fabricating the controllable liquid transport materials comprising treating a first region of the materials to become hydrophobic, treating discretely distributed second region(s) throughout the material with different shapes to have a gradient wettability or varied wettabilities and/or pore sizes for passively controllable liquid transport, and/or incorporating smart materials for actively controllable liquid transport being driven by external forces (e.g., electroosmotic force and/or ultrasonic oscillation).

The controllable liquid transport material or preparation methods thereof can realize controllable transport of a liquid in the material.

The controllable liquid transport material such as a textile material or fabric allows passively directional liquid transport by capillary action whilst actively regulated liquid transport by external stimuli such as electric voltage, temperature and/or ultrasonic oscillation.

The controllable liquid transport material such as a textile material or fabric allows directional liquid transfer with resistance and repellence of external liquids, clinging reduction and high breathability.

A low voltage electric field can be applied on both sides of the material for actively controlling the liquid transport.

Preparation of the present material such as fabric including a first region with hydrophobicity and a second region(s) discretely distributed throughout the material with different shapes having a gradient wettability or varied wettabilities and/or pore sizes can be achieved by any textile processing method and chemical treatment processes for existing commercial fabrics.

The controllable liquid transport material of the present invention (e.g., a textile material, e.g., a fabric) can be covered and laminated by a breathable protective shell for liquid transport and collection, keeping the material breathable and waterproof.

Accordingly, a first aspect of the present invention provides a controllable liquid transport material comprising a hydrophobic first region and one or more second regions, wherein each of the second regions comprises a first surface and a second surface, and wherein:
the first surface has a wettability of less than that of the second surface; and
either or both of the first surface and the second surface has an area of at least 1 mm².

In certain embodiments, the controllable liquid transport material is obtained by one or more of the following methods:
(a) obtaining the material having the first region and the second region(s) by subjecting a hydrophobic material to a hydrophilic treatment (e.g., a plasma process, a screen printing process, a spraying process, etc.), wherein by controlling the hydrophilic treatment, the first surface of the second region is configured to have a smaller wettability than that of the second surface of the second region, and/or the area of the first and/or second surface is obtained;
(b) obtaining the material having the first region and the second region(s) by subjecting a hydrophilic material to a hydrophobic treatment and a hydrophilic treatment, respectively, wherein by controlling the hydrophilic treatment, the first surface of the second region is configured to have a smaller wettability than that of the second surface, and/or the area of the first and/or second surface is obtained;
(c) obtaining the controllable liquid transport material by methods including knitting (e.g., platedwork, intarsia, jacquard), weaving, stitching or embroidering to produce yarns with periodically distributed hydrophobic and hydrophilic segments such that the first region is formed from the hydrophobic segments and the second region(s) is/are formed from the hydrophilic segments, wherein by adjusting the distribution density and/or size of the yarns, the first surface of the second region is configured to have a smaller wettability than that of the second surface and/or the area of the first and/or second surface is obtained; and/or
(d) obtaining the controllable liquid transport material by methods including knitting (e.g., platedwork, intarsia, jacquard), weaving, stitching or embroidering to produce hydrophobic and hydrophilic yarns, such that the first region is formed from the hydrophobic yarns and the second region(s) is/are formed from the hydrophilic yarns, wherein by adjusting the distribution density and/or the size of the respective yarns, the first surface of the second region is configured to have a smaller wettability than that of the second surface and/or the area of the first and/or second surface is obtained.

In certain embodiments, the controllable liquid transport material comprises a first and a second layers arranged adjacent to each other, wherein the first layer is hydrophobic, and the second layer comprises the hydrophobic first region and the one or more second regions. In certain embodiments, the first layer is formed from hydrophobic yarns, and the second layer is formed by one or more of the methods (a)-(d) as described in the foregoing embodiments.

In the embodiments where the controllable liquid transport material comprises the first and second layers arranged adjacent to each other,
the controllable liquid transport material is formed from hydrophilic and hydrophobic yarns by weaving using plating, such that the hydrophobic yarns constitute the first layer and the hydrophilic yarns constitute the second layer, wherein the second layer is subjected to hydrophobic treatment and hydrophilic treatment to have the first region and the second region, respectively; or
the controllable liquid transport material is formed from hydrophobic yarns and yarns having periodically distributed hydrophobic and hydrophilic segments by weaving using plating, such that the hydrophobic yarns constitute the first layer and the yarns having periodically distributed hydrophobic and hydrophilic segments constitute the second layer.

In certain embodiments, wherein the wettability from the first surface to the second surface is varied in gradient; and/or the controllable liquid transport material comprises a plurality of second regions and the plurality of second regions are locally contacted or completely separated.

A second aspect of the present invention provides a controllable liquid transport material comprising a hydrophobic first region and one or more second regions, each of the second regions comprising a first surface and a second surface, wherein:
each of the second regions further comprises a smart material configured to directionally transport liquid from the first surface to the second surface when required.

In certain embodiments, the smart material is a temperature-sensitive material coated on the second surface, such that when the second surface is changed from a hydrophobic surface to a hydrophilic surface upon the ambient temperature reaches a threshold temperature, liquid is directionally transported from the first surface to the second surface. In certain embodiments, the smart material is further provided with a thermally conductive wire in contact with the second region, optionally the thermally conductive wire being an electrical wire or coated thereon with an electrically conductive coating or integrated with a heat-sensitive element, thereby the temperature-sensitive material is heated to become hydrophilic when the power to the thermally conductive wire is on.

In certain embodiments, the second region is hydrophilic, and the first surface and the second surface are provided with a first electrode and a second electrode, respectively, and the liquid is directionally transported from the first surface to the second surface when the first electrode is connected to a negative terminal of a power supply and the second electrode is connected to a positive terminal of the power supply.

In certain embodiments, the second region is hydrophilic, and the second surface is attached with an ultrasonic oscillating atomizing sheet configured to release the liquid being transported to the second surface to the air when the first surface transports the liquid to the second surface, directing the liquid to continuously flow from the first surface to the second surface.

A third aspect of the present invention provides a controllable liquid transport material comprising a hydrophobic first region and one or more second regions, each of the second regions having a first surface and a second surface,
wherein the second region comprises channels through the controllable liquid transport material and is hydrophilic, the channels defining a first position, a first surface area, and/or a first pore size on the first surface, and the channels defining a second position, a second surface area, and/or a second pore size on the second surface, such that when in use: (1) the first position is higher than the second position or the first position is equal or substantially equal in height to the second position; and/or (2) the first pore size is greater than the second pore size.

In certain embodiments, the first surface area is at least 1 mm², and/or the second surface area is at least 1 mm²; or the first pore size is about 0.2-8000 µm, and/or the second pore size is about 0.1-2000 µm.

In certain embodiments, when in use, the first position is higher than the second position or the first position is equal or substantially equal in height to the second position, and the channels are Z-shaped, trapezoidal, conical, or deformed Z-shaped. Optionally, the deformed Z-shape is configured such that an angle between two short-transverse lines (upper and lower, respectively) and a connecting line defined between the two transverse lines is a right angle or an obtuse angle.

In certain embodiments, the controllable liquid transport material is woven by a weaving method, wherein the first pore size is greater than the second pore size, wherein the channels are configured to have different pore sizes in terms of their thickness by adjusting the distribution density and/or size of the yarns, and wherein the yarns forming the channels are hydrophilic or treated to be hydrophilic.

In certain embodiments, the controllable liquid transport material comprises a plurality of second regions and the plurality of second regions are partially contacted with each other or completely separated.

A fourth aspect of the present invention provides a controllable liquid transport system comprising a first fibrous electrode layer as an inner layer, a second fibrous electrode layer as an outer layer, a porous nanofibrous membrane layer as a middle layer disposed between the inner and outer layers, and optionally at least two porous adhesive layers disposed on both sides of the middle layer, wherein the second fibrous electrode layer comprises a first region and hydrophilic second region(s), wherein each of the second regions comprises a first surface and a second surface, and the middle layer has a submicron scale pore size.

In certain embodiments, the fibrous electrode layer is prepared by coating an electrically conductive polymer on fibers. Optionally, the first fibrous electrode layer and the second fibrous electrode layer are composed of an electrode material selected from carbon fibers, carbon nanotubes, graphene, metals, or any combination thereof.

In certain embodiments, the area of the first surface is at least 1 mm², and/or the area of the second surface is at least 1 mm²; and/or the second fibrous electrode layer comprises a plurality of second regions and the plurality of second regions are partially contacted with each other or completely separated.

In certain embodiments described in the above aspects, the second region in the controllable liquid transport material or system has a shape selected from the group consisting of: rectangle, triangle, oval, diamond, circle, square, Y-shaped, +-shaped, tree-shaped, web-shaped, Z-shaped, or variations thereof, or any combination thereof.

In certain embodiments of any aspects described hereinabove, the controllable liquid transport material is made of a natural and/or synthetic material. Optionally, the natural material is selected from cotton, wool, silk, flax, bamboo fiber, or any combination thereof; and/or the synthetic material is selected from Teflon, polypropylene fiber, Terylene, chinlon, Acrylon, Spandex, Nylon, or any combination thereof.

A fifth aspect of the present invention provides a controllable liquid transport article comprising an inner layer, an outer layer, a middle layer disposed between the outer layer and the inner layer, and optionally at least two porous adhesive layers disposed on both sides of the middle layer, wherein the inner layer is composed of the controllable liquid transport material or system according to any of the embodiments of the aspects described hereinabove; the outer layer is composed of a breathable, waterproof material; and the middle layer is hydrophobic and provided with hollow channels thereon.

In certain embodiments, the article further comprises a sealing layer at the edges of the inner layer, the middle layer, the outer layer, and the porous adhesive layers. The sealing layer is configured to collect accumulated liquid in the article or prevent the accumulated liquid from rolling off the article when the article is used.

A sixth aspect of the present invention provides an article composed of the controllable liquid transport material, article or system according to any of the embodiments of the aspects described hereinabove. Optionally, the article of the sixth aspect comprises a towel, a handkerchief, a sports guard, a bedding, a sportswear garment, a casual coat, a firefighter protective clothing, a winter jacket, a protective fabric, an insulation garment, a military garment, an industrial workwear garment, an oil/water separator, a wound dressing, or a microfluidic device.

This summary is provided to introduce a selection of concepts in a simplified form that are further described below in the Detailed Description. This Summary is not intended to identify key features or essential features of the claimed subject matter, nor is it intended to be used as an aid in determining the scope of the claimed subject matter. Other aspects of the present invention are disclosed as illustrated by the embodiments hereinafter.

### BRIEF DESCRIPTION OF DRAWINGS

The appended drawings, where like reference numerals refer to identical or functionally similar elements, contain figures of certain embodiments to further illustrate and clarify the above and other aspects, advantages and features of the present invention. It will be appreciated that these drawings depict embodiments of the invention and are not intended to limit its scope. The invention will be described and explained with additional specificity and detail through the use of the accompanying drawings in which:

FIG. 1 shows a structural schematic of a controllable liquid transport fabric.

FIG. 2 shows a schematic of fabrication procedures for the controllable liquid transport fabric with varied wettabilities in the second regions with different shapes. As shown, the fabric was first dipped with octamethylcyclotetrasiloxane (D4) and then subjected to plasma treatment to initiate D4 polymerization, thereby imparting hydrophobicity to the fabric; next, both sides of the fabric are covered with two molds with a hollow pattern, respectively (i.e., the area of the fabric corresponding to the pattern is not covered by a mold), and then plasma etching is performed, thereby generating localized regions with wettability, wherein the magnitude of wettability of the localized regions can be controlled by controlling the scanning rate and the exposure time length of the plasma.

FIG. 3 shows: (a) contact angles of the exposed side and the unexposed side of the fabric to plasma etching; (b) dynamic variation of contact angles of the plasma treated fabric at the plasma scan speed of 0.1 mm/s.

FIG. 4 shows SEM images of cotton fabric treated by plasma etching: (a) the unexposed side; (b) the exposed side at the scan speed of 0.5 mm/s and (c) the exposed side at the scan speed of 0.1 mm/s; and (d) FTIR spectra of D4, cotton fabric, and D4-treated cotton fabric (where the three curves represent D4, cotton, and D4-treated cotton fabric, respectively, from top to bottom); (e) FTIR spectra of D4-treated cotton fabrics before and after plasma etching (where the upper curve represents before plasma etching and the lower curve represents after plasma etching).

FIG. 5 shows a directional liquid transport through an inclined, controllable liquid transport fabric with water droplets supplied from the skin side and the face side, respectively.

FIG. 6 shows a directional liquid transport through a horizontally disposed, controllable liquid transport fabric according to certain embodiments with water droplets supplied to (a) the skin side (first row of images) and (b) the face side (second row of images), respectively; (c) an image of water droplets on the surface of hydrophobic (left sample) and hydrophilic (right sample) regions, respectively; (d) illustration of water column on the top of the fabric from face side to skin side; (e) a schematic showing a liquid absorption measurement of both sides of a fabric by a moisture management tester (MMT); (f) water contents of both sides of the controllable liquid transport fabric in the MMT.

FIG. 7 shows pulling forces required to move the fabrics of the present invention on a simulated sweaty skin.

FIG. 8 shows a schematic of fabrication procedures for the controllable liquid transport fabric according to certain embodiments with varied wettabilities in the second regions using sustainable materials and methods: as seen, the cotton fabric is firstly dipped with D4; next, both sides of the fabric are covered with two molds, respectively (i.e., localized regions are covered to expose main regions), and plasma treatment is performed to induce D4 polymerization, thereby making the main region as hydrophobic; the mold on one side of the fabric is then removed to induce D4 polymerization by plasma treatment to produce varied wettabilities across the thickness of the localized regions, wherein the degree of wettability of the localized regions can be controlled by controlling the time duration of the plasma treatment.

FIG. 9 schematically depicts the structure of a waterproof, protective fabric with controllable liquid transport properties according to certain embodiments: the fabric system comprises an inner layer (composed of the controllable liquid transport fabric of the present invention), a middle layer (being a spacing and support layer) and an outer layer (composed of a waterproof, breathable fabric), wherein the middle layer is disposed between the inner layer and the outer layer; the middle layer is hydrophobic and is provided with channels through which liquid molecules pass; optionally, the fabric system further comprises a first nonwoven fusible interlining disposed between the outer layer and the middle layer and a second nonwoven fusible interlining disposed between the inner layer and the middle layer for bonding the inner, middle and outer layers together.

FIG. 10 shows a series of images for a directional liquid transport through an inclined, controllable liquid transport, waterproof, and protective fabric according to certain embodiments under a supply of water droplets to the skin side (upper row) and the face side (lower row), respectively.

FIG. 11 shows a structural schematic of a controllable liquid transport, waterproof, and protective fabric according to certain embodiments having the boundary edges sealed for sweat collection.

FIG. 12 shows an overall or regional temperature change of the protective fabrics on a skin in different conditions under a constant air flow over time.

FIG. 13 shows the moisture vapor transmission rates of the protective fabric system, a Gore-Tex waterproof layer, a controllable liquid transport cotton fabric, and untreated cotton fabric (which respectively correspond to the fourth, third, second and first columns in the figure).

FIG. 14 shows a schematic of a method of fabricating a controllable liquid transport fabric according to certain embodiments with localized, fully hydrophilic channels: as seen, the fabric is first covered by two 3D printing molds with controllable patterns (the patterns corresponding to the localized regions, i.e., the localized regions are covered and the main regions are uncovered) followed by spraying with a hydrophobic TiO₂ solution.

FIG. 15 shows images from a side view depicting spontaneous liquid supply to and removal from the controllable liquid transport fabric according to certain embodiments with localized hydrophilic regions.

FIG. 16 shows a schematic of an internal structure of a controllable liquid transport fabric according to certain embodiments with localized hydrophilic regions with long channels within the fabric.

FIG. 17 shows (a) fabrication of a woven fabric by plating, where the two opposite sides thereof are composed of yarns with different properties; (b) a schematic of the woven fabric with one side being hydrophilic and the other being hydrophobic; (c) a schematic of a woven fabric having localized regions (i.e., second regions) with different shapes and varied wettabilities across the thickness thereof.

FIG. 18 shows a directional liquid transport through an inclined, controllable liquid transport woven fabric according to certain embodiments with water droplets supplied to the skin side thereof.

FIG. 19 shows images of a liquid transport rate test on a woven fabric (prepared according to Example 4) which is placed on a simulated sweaty skin with a water supply rate of 5ml/h.

FIG. 20 shows the differences in (a) instantaneous contact temperature-sensing standard (Q-max), (b) thermal conductivity, and (c) temperature between untreated cotton fabric, a fabric with asymmetric wettabilities across the thickness, and a controllable liquid transport woven fabric upon contacting a given liquid source.

FIG. 21 shows schematically the structure of a controllable liquid transport fabric system according to certain embodiments with varied pore sizes in the localized regions thereof.

FIG. 22 shows schematically the structure of a controllable liquid transport fabric system according to certain embodiments with a liquid transport driven by electric voltage.

FIG. 23 shows a liquid transport from the inner to the outer sides of the controllable liquid transport fabric according to Example 6 under an influence of electroosmotic flow (upper two rows) or stored within the fabric when the power is off (lower two rows).

FIG. 24 shows a penetration pressure of the water column required by the liquid on the outer side of the controllable liquid transport fabric according to Example 6 to penetrate into the fabric under the power on (upper row) and off (lower two rows) status.

FIG. 25 shows schematically (a) the structure of a temperature-sensitive fabric according to certain embodiments locally (i.e., the second region) coated with a temperature-sensitive material; and (b) a side view of the temperature-sensitive fabric having thermally conductive wires in the yarns.

FIG. 26 shows a flow chart of the method of preparing the controllable liquid transport fabric of the present invention.

FIG. 27 shows schematically the structure of a controllable liquid transport fabric system according to certain embodiments with a liquid transport driven by ultrasonic oscillation.

### DETAILED DESCRIPTION OF THE INVENTION

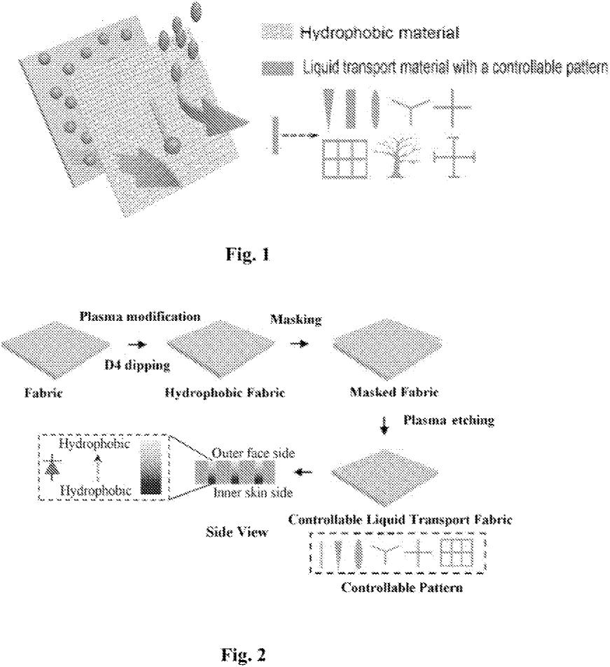

The present invention provides a controllable liquid transport fabric and fabrication method thereof (FIG. 1). The first region of the fabric is treated to be hydrophobic, while a plurality of discretely distributed, second regions with different shapes are treated to have a gradient wettability or varied wettabilities and/or pore sizes for passively controllable liquid transport, and/or integrated with smart materials for actively controllable liquid transport driven by external forces (such as electroosmotic force or ultrasonic oscillation). Preferably, the first region is continuously distributed. The shapes and/or patterns of the second regions may include rectangle, triangle, oval, diamond, circle, square, Y-shape, +-shape, tree-shape, web-shape, Z-shape, etc., or variations thereof, or any combination thereof. The fabric of the present invention allows efficiently and controllably directional transport of liquids (e.g., sweat), blocking external liquids, reducing stickiness, whilst keeping the fabric breathable and dry. More specifically, the discretely distributed, second regions exhibit a gradient or varied wettabilities or pore sizes across the thickness, where the liquid is continuously transported from the inner side to the outer side and then accumulated, growing into larger liquid droplets until they roll off under a synergic effect of capillary force and gravity. Simultaneously, external liquids are blocked by the opposite side, making them easily roll off along the fabric’s outer surface. The hydrophobicity of the surroundings (the first region) and the varied wettabilities of the second regions can be established by plasma modification, plasma etching, hydrophobic spray coating, UV treatment, and/or programmable knitting, weaving, or stitching using hydrophilic and hydrophobic yarns. The shapes of the second regions can be controlled with the utilization of masks made by tapes or 3D printing molds during wettability treatment, and based on programmable weaving, knitting, or stitching with periodic changes in wettability using hydrophobic and hydrophilic yarns. Moreover, the pore size can be varied across the whole thickness by changing the through-thickness yarn density, with the above wettability treatment to enable a controllable liquid transport. In addition to a passive liquid transport mechanism, external stimulations (e.g., temperature, electric voltage and ultrasonic vibration) may be applied to exert an active control of the liquid transport. It is possible to change the wettability of the fabric with the temperature as long as the fabric is coated with a temperature-responsive material (e.g., a material that can be changed from hydrophobic to hydrophilic after heating), while the fabric is integrated with active heating elements (e.g., heating wires or inks). The liquid transport can also be controlled by a combination of electroosmotic and capillary forces through added electrodes onto the fabric systems, especially to the second regions, with variation among power on-, off-, accelerated, decelerated, and direction-inverse modes.

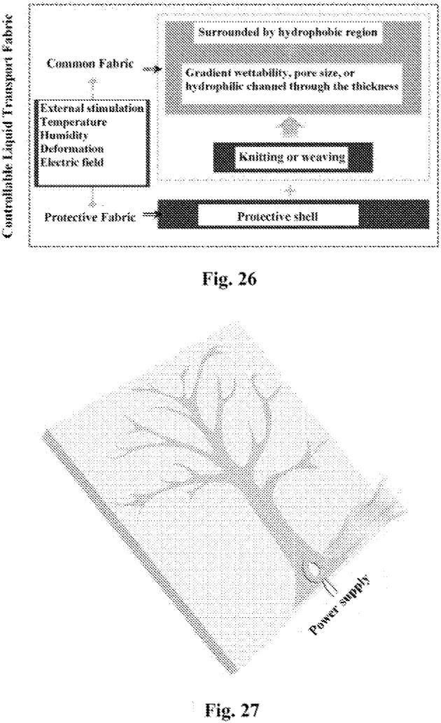

In summary, the liquid transport may be passive driven by capillary force and gravitational force, and active driven by electrical potential, temperature or ultrasonic oscillation. The fabric substrate can be made of natural materials such as cotton, wool, silk, and linen, or synthetic materials such as polyester and/or nylon (FIG. 26). The yarns for fabricating the fabrics can also be made of natural materials such as cotton, wool, silk, or linen, and synthetic materials such as polyester and/or nylon. The fabrication of yarns or fibers to obtain the fabrics includes one or more weaving, knitting, and stitching methods. The wettability treatment of the entire fabric or the first region and/or the second region can be performed by plasma modification method, UV modification, plasma etching method, chemical etching method, solution infiltration, laser electrodeposition, template deposition, nanoparticle deposition, spray coating, etc. The spacing layer used in the protective fabric includes knitted spacers, woven spacers, 3D printing layers, molded layers, etc.

In addition, the present inventors have unexpectedly found that employing a larger area for the second region of the controllable liquid transport fabric may have the following advantages over a smaller area for the same: the directional transport of the liquid is assured, and the liquid transport efficiency is higher. Increasing the second region surface area is more beneficial to liquid transfer from the inner side to the outer side of the fabric to facilitate accumulation thereof into larger liquid droplets until they roll off the surface under a synergistic effect of gravity and capillary force. In contrast, the liquid droplets formed in the smaller areas of the second region will be adsorbed on the surface by the action of the capillary force, which makes it harder for the droplets to grow into larger droplets and roll off. Moreover, the increase in the first surface area contributes to more adequate contact between the moisture-transport area at the inner side of the fabric and the liquid, thereby increasing the water-guiding area. At the same time, the increase in the first surface area also contributes to the interconnection between second regions, thereby facilitating drainage and export of liquid. In certain embodiments, the area of the first surface is at least 1 mm²; and/or the area of the second surface is at least 1 mm².

### 1. Definitions

As used herein, reference to the controllable liquid transport material of the present invention “comprising a first region and a plurality of partially contacted or completely separated second regions” or the like also includes the case where the controllable liquid transport material “consists of or consists essentially of a first region and a plurality of partially contacted or completely separated second regions”.

In embodiments of various aspects of the present invention, a “first surface” generally refers to a surface of a material that, in use, is in contact with a surface of an object (e.g., skin) from which liquid needs to be removed or in a closer proximity to the surface of the object (e.g., skin) relative to a “second surface,” unless the context clearly dictates otherwise. Similarly, a “second surface” generally refers to a surface of a material more distal to the surface of the object (e.g., skin) relative to the “first surface”, unless the context clearly dictates otherwise. Thus, in certain cases, a “first surface” or the surface at which the “first surface” is located generally corresponds to the “skin side”, “inner side”, or “inner surface” described in the present invention, unless the context clearly dictates otherwise. Similarly, in certain cases, a “second surface” or the surface at which the “second surface” is located generally corresponds to the “face side”, or “outer side”, or “outer surface” described in the present invention, unless the context clearly dictates otherwise.

“Mold covering/masking” used herein refers to covering a material or fabric with a mold having a particular pattern and/or shape (e.g., a hollow or solid pattern), and treat the exposed material, e.g., a part of the fabric (e.g., the first region or the second region(s)) by means of plasma etching or the like, to make it hydrophobic or hydrophilic or have varied wettabilities or a gradient wettability.

As used herein, the expression “hydrophobical” or “hydrophobic” etc. refers to the water-repellent physical properties of the surface of a material, layer, or structure (e.g., the first region or major region), i.e., water droplets are impossible or difficult to adhere, infiltrate, or diffuse on the surface of a hydrophobic substance. The hydrophobicity is generally represented by the contact angle (θ). The contact angle of the hydrophobic surface is generally greater than 90 degrees to less than or equal to 180 degrees. In the present invention, “moderately hydrophobic” refers to the contact angle of the surface that is generally from greater than 90 degrees to less than or equal to 120 degrees. “Highly hydrophobic” refers to the contact angle of the surface that is generally from greater than 120 to less than or equal to 180.

As used herein, the expression “hydrophilical” or “hydrophilic” etc. refers to the surface of a material, layer, or structure (e.g., the second region or localized region) that has a greater affinity to water so that water droplets are prone to or easily adhere, infiltrate, or diffuse on the surface of a hydrophilic substance. The contact angle of the hydrophilic surface is typically between 0 degree and 90 degrees. “Wettability” or the like refers to the hydrophilicity or hydrophobicity of a material, which can be quantified by the contact angle. In the present invention, “moderately hydrophilic” refers to the contact angle of the surface that is generally from greater than or equal to 30 degrees to less than or equal to 90 degrees. “Highly hydrophilic” refers to the contact angle of the surface that is generally from 0 degree to less than 30 degrees.

In the present invention, “hydrophobical treatment” and “hydrophobic treatment” may be used interchangeably; likewise, “hydrophilical treatment” and “hydrophilic treatment” may also be used interchangeably.

In the present invention, when reference is made to “the controllable liquid transport material comprises first and second layers arranged adjacent to each other”, the first and second layers may be separate layers or may be both front and back sides of a fabric made of yarns with different properties. For example, in the case where the first layer is formed from hydrophobic yarns and the second layer is formed by one or more of the methods (a)-(d) as described in embodiments of the present invention, the first and second layers may refer to two opposite sides (front and back sides) of a fabric.

In the present invention, when reference is made to “the first position being equal or substantially equal in height to the second position”, the term “substantially” used therein refers to the heights of the first position and the second position differ by no more than 5%, for example, the height of the first position may be 95%, 96%, 97%, 98%, 99% or 100% of that of the second position, and vice versa.

In the present invention, when reference is made to “a plurality of second regions being partially contacted”, the term “partially contacted” refers to which two or more second regions are in partial contact. In other words, the term “partial contact” may refer to which the first surface and/or the second surface of the two or more second regions are interconnected with each other to form a continuous surface, or which the boundary (or contour) of the first surface of and/or the boundary (or contour) of the second surface of the two or more second regions are interconnected or overlap with each other to form a continuous boundary (or contour). For example, the two or more second regions may form a continuous region throughout the material (e.g., fabric) by partial contact, or form a plurality of discontinuous regions distributed discretely over the material, etc. For example, partial contact may include 1-99%, 5-95%, 10-90%, 15-85%, 20-80%, 25-75% of the contact (based on an average area of every two of the first or second surfaces in contact with each other) or any ranges or values therebetween.

### 2. Controllable Liquid Transport Material With Varied or Gradient Wettability Between the First and Second Surfaces of the Second Region

Certain embodiments of the present invention provide a controllable liquid transport material comprising a hydrophobic first region and one or more second regions, wherein the second region comprises a first surface and a second surface (i.e., defined on two opposite sides of the material, respectively), wherein the wettability of the first surface of the second region is less than the wettability of the second surface thereof.

In certain embodiments, the area of the first surface is at least 1 mm² and/or the area of the second surface is at least 1 mm².

In certain embodiments, the wettability of the second region across the thickness from the first surface to the second surface increases (e.g., gradiently increases, which may be achieved, for example, by hydrophilic treatment). For example, the second region has a gradually or gradiently increased wettability across the thickness from the first surface to the second surface after the hydrophilic treatment.

In certain embodiments, the controllable liquid transport material is obtained by subjecting the material to a hydrophobic treatment and/or a hydrophilic treatment. For example, the material may be first subjected to a hydrophobic treatment to render the entire material hydrophobic; the second region is then subjected to a further hydrophilic treatment so that the second region is hydrophilic, wherein the first surface of the second region has a smaller wettability than that of the second surface and/or the area of the first and/or second surface is obtained by controlling the extent of the hydrophilic treatment (e.g., controlling the plasma scanning rate and/or the treatment time in the case of plasma etching). In the case where the material itself is a hydrophobic material, the second region on the material is directly subjected to a hydrophilic treatment without performing a hydrophobic treatment.

In certain embodiments, the controllable liquid transport material is woven with yarns having periodically distributed hydrophobic and hydrophilic segments by conventional weaving methods, e.g., knitting (such as platedwork, intarsia, jacquard), weaving, stitching or embroidery, etc.). Preferably, the density of the second regions is made different in terms of thickness by adjusting the distribution density and/or the size of the yarns such that the wettability of the first surface of the second region is smaller than that of the second surface and/or the area of the first surface and/or the second surface is obtained. Alternatively, the second region formed by the hydrophobic yarn may also be subjected to a hydrophilic treatment such that the first surface of the second region has a smaller wettability than that of the second surface and/or an area of the first surface and/or the second surface is obtained. Optionally, the controllable liquid transport material may be woven directly using fibers having periodically distributed hydrophobic and hydrophilic segments instead of yarns.

### 3. Controllable Liquid Transport Material With Varied or Gradient Wettability Between the First and Second Surfaces of the Second Region

Certain embodiments of the present invention provide a controllable liquid transport material comprising first and second layers arranged adjacent to each other, wherein the first layer is hydrophobic, and the second layer comprises a hydrophobic first region and one or more second regions, wherein the second region is hydrophilic.

In some preferred embodiments, the second region comprises (or defines) a first surface and a second surface, and the wettability of the first surface is less than that of the second surface. Optionally, the area of the first surface is at least 1 mm² and/or the area of the second surface is at least 1 mm².

In certain embodiments, the controllable liquid transport material is prepared by weaving hydrophilic yarns and hydrophobic yarns so that the hydrophobic yarns constitute the first layer and the hydrophilic yarns constitute the second layer, wherein the second region of the second layer is made hydrophilic or has varied wettability or gradient wettability in thickness by hydrophobic treatment or a combination of hydrophobic treatment and hydrophilic treatment. For example, the hydrophobic treatment may comprise subjecting only the second layer to a hydrophobic treatment. Optionally, the controllable liquid transport material may be woven directly using fibers instead of yarns.

In certain embodiments, the controllable liquid transport material may be prepared with hydrophilic yarns (or fibers) and hydrophobic yarns (or fibers) using a plating method in knitting technology, wherein the hydrophobic yarns (or fibers) are woven into a first layer and the hydrophilic yarns (or fibers) are woven into a second layer, and then the first region of the hydrophilic second layer is treated to be hydrophobic (or alternatively, the second layer as a whole may also be treated to be hydrophobic, and then the second region is subjected to a hydrophilic treatment, wherein the degree of wettability of the second region across the thickness can be controlled, for example, by controlling the scanning rate or time duration of the plasma treatment. Alternatively, the controllable liquid transport material may be prepared with hydrophobic yarns (or fibers) and yarns (or fibers) with periodic hydrophobic and hydrophilic segments using a plating method in knitting technology, wherein the hydrophobic yarns (or fibers) are woven into a first layer and the yarns (or fibers) with periodic hydrophobic and hydrophilic segments are woven into a second layer to form a hydrophobic first region and a hydrophilic second region on the second layer. Optionally, the degree or gradient of the wettability of the second region may be adjusted by adjusting the distribution density and/or size of the fibers or yarns.

### 4. Controllable Liquid Transport Material Comprising Smart Materials in the Second Region

Certain embodiments of the present invention provide a controllable liquid transport material comprising a first region and one or more second regions, wherein the second region comprises a first surface and a second surface, wherein the second region is hydrophilic or, becomes hydrophilic when needed.

In certain embodiments, the second region comprises a smart material (e.g., a temperature-sensitive material) configured to transport liquid from the first surface to the second surface when liquid transport is required. In certain embodiments, the first region is hydrophobic, the first surface of the second region is hydrophobic, and the second surface is coated with a temperature-sensitive material (e.g., hydrogel, which is hydrophobic at lower temperatures and hydrophilic at higher temperatures), wherein the second surface becomes hydrophilic (thereby enabling liquid such as sweat to be transferred from the first surface to the second surface) after the ambient temperature (e.g., including the body temperature of the wearer when the material is made into a garment for wear) reaches a threshold value (e.g., about 35° C.), whereas the second surface remains hydrophobic when the ambient temperature is below the threshold value. Those skilled in the art will appreciate that the threshold temperature, i.e., the critical temperature at which the hydrophobicity or hydrophilicity of the temperature-sensitive material changes, will vary depending on the temperature-sensitive material selected. Those skilled in the art can select a temperature sensitive material with a suitable threshold temperature according to the specific application.

In a further embodiment, a thermally conductive wire in contact with the second region is disposed in the controllable liquid transport material, wherein the temperature-sensitive material on the second surface is heated to become hydrophilic when the thermally conductive wire is energized to heat, thereby directing liquid transport from the first surface to the second surface. In certain embodiments, the thermally conductive wire is an electrical wire or coated with an electrically conductive coating thereon or integrated with a temperature-sensitive element.

In certain embodiments, a first electrode may be provided on the first surface or the surface of the first region adjacent to the first surface, and a second electrode may be provided on the second surface or the surface of the first region adjacent to the second surface, and the liquid in the material flows from the first surface to the second surface in the presence of electric potential under a power supply when the first electrode is connected to the negative electrode of a power supply and the second electrode is connected to the positive electrode of the power supply.

In other embodiments, the second region is hydrophilic, and the second surface may be attached with an ultrasonic oscillating atomizing sheet. When the first surface transports liquid to the second surface, a power supply can be connected to activate the atomizing sheet, such that the ultrasonic oscillating atomization sheet can convert the liquid transported to the second surface into liquid particles of small particulates through high-frequency resonance and subsequently release them to the air, causing a continuous liquid flow from the first surface to the second surface.

In some other embodiments, a portable power supply device or battery unit may be incorporated into the controllable liquid transport material in order to more conveniently control the transport of liquid in the material. It is also possible not to incorporate a power supply and a battery into the material, but instead connect the material to an external power supply or battery in order to provide electric potential.

In certain embodiments, the wettability of the first region is not particularly limited in the case of actively (e.g., through the use of electric field or ultrasonic vibrations) controlling the liquid transport. In certain embodiments, the first region may be hydrophobic or moderately hydrophobic. In other embodiments, the first region may even be hydrophilic in the case of actively controlling liquid transport.

### 5. Controllable Liquid Transport System Composed of Bilayer Fibrous Electrode Layers

Certain embodiments of the present invention provide a controllable liquid transport system comprising a first fibrous electrode layer (as an inner layer), a second fibrous electrode layer (as an outer layer), and a porous nanofibrous membrane layer (as a middle layer) disposed between the inner and outer layers, wherein the second fibrous electrode layer comprises a first region and one or more second regions, wherein each of the second regions comprises a first surface and a second surface, wherein the second region is hydrophilic, and the middle layer has submicron scale pore size.

In certain embodiments, the system may further include at least two porous adhesive layers (e.g., highly porous nonwoven fusible interlinings) on both sides of the middle layer for bonding (e.g., by lamination) the layers together.

In certain embodiments, the fibrous electrode layer is prepared by coating a conductive polymer (e.g., poly(3,4-ethylenedioxythiophene) blended with polystyrene sulfonate) on fibers, and then causing the liquid to move under the effect of electroosmotic flow by applying an electric field, (e.g., the liquid flows from the inner layer to the outer layer and moves continuously from the first surface to the second surface of the outer layer under the effect of an electric field induced coulomb force). In certain embodiments, the first and second fibrous electrode layers may be composed of the following electrode materials: carbon fibers, carbon nanotubes, graphene, metals, or any combination thereof.

In certain embodiments, the porous nanofibrous membrane used to make the middle layer may be a nylon membrane with a pore size of about 0.45 µm. In certain embodiments, the porous nanofibrous membrane used to make the middle layer may be moderately hydrophilic Nylon 6,6 or highly hydrophilic Polyacrylonitrile (PAN), such as a nanofiber Nylon 6,6 membrane with submicron scale pore size.

In certain embodiments, the first region may be hydrophobic or hydrophilic, preferably hydrophobic.

In some other embodiments, a portable power supply device or battery unit may also be incorporated into the system in order to more conveniently control the transport of liquid in the material. It is also possible not to incorporate a power supply and a battery into the material, but instead connect the material to an external power supply or battery in order to provide an electrical potential.

### 6. Controllable Liquid Transport Material Comprising Channels Throughout the Material in the Second Region

Certain embodiments of the present invention provide a controllable liquid transport material comprising a hydrophobic first region and a plurality of second regions, wherein each of the second regions has a first surface and a second surface and comprises channels through the controllable liquid transport material which are hydrophilic, the channels defining a first position, a first surface area, and/or a first pore size on the first surface, and defining a second position, a second surface area, and/or a second pore size on the second surface, wherein: (1) in use, the first position is higher than the second position or the first position is equal or substantially equal in height to the second position; and/or (2) the first pore size is greater than the second pore size.

In certain embodiments, the first surface area is at least 1 mm²; and/or the second surface area is at least 1 mm². In certain embodiments, the first pore size is about 0.2-8000 µm and the second pore size is about 0.1-2000 µm.

In certain embodiments, the controllable liquid transport material is prepared by covering both sides of the material with 3D printing molds having controllable patterns (e.g., hollow patterns) followed by a hydrophobic TiO₂ solution spraying. In other embodiments, the material is hydrophobic prior to treatment, so that the method of preparing the controllable liquid transport material of the present invention may omit the step of TiO₂ solution spraying.

In certain embodiments, the controllable liquid transport material is woven with yarns by a weaving method, e.g., knitting (such as platedwork, intarsia, jacquard), weaving, stitching and embroidering, etc., wherein the channels are configured to have different pore sizes across the thickness by adjusting the distribution density and/or the yarn size of the yarns, and wherein the yarns forming the channels are hydrophilic or treated to be hydrophilic. Optionally, the controllable liquid transport material may be woven using fibers instead of yarns.

In certain embodiments, when in use, the first position is higher than the second position or the first position is equal or substantially equal in height to the second position, and the channels can be in any shape, such as Z-shaped, trapezoidal, conical, and the like. In certain embodiments, the channels are Z-shaped or deformed Z-shaped, wherein the deformed Z shape is configured such that an angle between two (upper and lower) short-transverse lines and the connecting line between them is a right angle or an obtuse angle.

In certain embodiments, the second region may only be formed by the channels which go through the controllable liquid transport material.

### 7. Controllable Liquid Transport Article

Certain embodiments of the present invention provide a controllable liquid transport article comprising an inner layer, an outer layer, and a middle layer disposed between the outer layer and the inner layer, wherein the inner layer is composed of the controllable liquid transport material described in any of the above embodiments of the present invention (e.g., any of the embodiments described in Sections 2-4 and 6) or a system described in the embodiments of Section 5; the outer layer is composed of a breathable, waterproof material (e.g., Gore-Tex); and the middle layer is hydrophobic and is provided with hollow channels (e.g., for passage of liquid molecules therethrough, such as a hollow channel cut by a laser). In certain embodiments, the middle layer serves as a spacing layer and support for supporting and providing air circulation for the article. Optionally, a spacing layer is also provided with a wearable fan to facilitate evaporative cooling. In certain embodiments, the spacing layer may be a 3D printed layer, a molding layer, or may be composed of a weft knit fabric, a warp knit fabric, or a woven fabric.

In certain embodiments, the article further comprises at least two porous adhesive layers (e.g., nonwoven fusible interlinings) on both sides of the spacing layer for bonding (e.g., by lamination) the layers together.

In certain embodiments, the article further comprises a sealing layer at the edges of the inner layer, the middle layer, the outer layer, and the porous adhesive layers, the sealing layer being configured to collect accumulated liquid in the article or prevent the accumulated liquid from falling off the article when the article is used.

### 8. Method for Preparing Controllable Liquid Transport Materials

Certain embodiments of the present invention provide a method of preparing the controllable liquid transport material described according to certain embodiments in the above Section 2 or 3 of the present disclosure, the method comprising:
(a) subjecting a substrate for preparing the controllable liquid transport material or a substrate for preparing a second layer of the controllable liquid transport material to a hydrophobic treatment to make it hydrophobic; otherwise, in the case where a hydrophobic substrate is provided, no hydrophobic treatment is performed; and
(b) subjecting one or more second regions of the material obtained in step (a) to a hydrophilic treatment such that the wettability of the first surface of the second regions is smaller than that of the second surface.

In some embodiment, the hydrophobic treatment comprises spraying a hydrophobic solution on both sides of the substrate or performing a plasma treatment or applying a chemical deposition method, and/or the hydrophilic treatment comprises a plasma etching method.

In certain embodiments, the step (b) further comprises: step (b1) covering a surface of the substrate on which the second surface is formed with a mold having a plurality of hollow patterns (e.g., the positions where the hollow patterns are located corresponding to the second region) before performing the hydrophilic treatment (e.g., plasma etching).

In certain embodiments, the pattern on the mold (e.g., a hollow pattern or a solid pattern) may include any shape as long as the objectives of the present invention are achieved. Optionally, the patterns are selected from rectangle, triangle, oval, diamond, circle, square, Y-shape, +-shape, tree-shape, web-shape, Z-shape, or variations thereof, or any combination thereof.

In certain embodiments, the applied plasma scan rate is about 1 mm/s to 0.1 mm/s during the plasma etching; the scan time is about 50s-500s, which varies depending on the size of the scanned sample and the scan speed (for example, scan time at a scan speed of 1 mm/s is 50s for a sample having a 5-cm length * 5-cm width).

In certain embodiments, prior to performing the hydrophobic treatment, the method further comprises: step (a1) desizing, washing and bleaching the substrate or any combination thereof.

9. Method for preparing controllable liquid transport materials comprising smart materials in the second region

Certain embodiments of the present invention provide a method of preparing the controllable liquid transport material described according to certain embodiments in Section 4 above, the method comprising:
(a) subjecting a substrate for preparing the controllable liquid transport material to a hydrophobic treatment so that both sides of the substrate are hydrophobic; and
(b) coating the surfaces (e.g., the second surfaces) of one or more second regions of the material obtained in step (a) with a temperature-sensitive material.

In certain embodiments, the method further comprises incorporating a thermally conductive wire into the material to be in contact with the second region, and/or incorporating a portable power supply device or battery unit into the material. In certain embodiments, the thermally conductive wire is an electrical wire or coated with an electrically conductive material or integrated with a temperature-sensitive element.

In certain embodiments, step (a) may be omitted when thermally conductive wire is incorporated into the material.

### 10. Method for Preparing Controllable Liquid Transport System Composed of Bilayer Fibrous Electrode Layers

Certain embodiments of the present invention provide a method of preparing the controllable liquid transport system described according to certain embodiments of Section 5 above of the present invention, the method comprising:
(a) preparing a first fibrous electrode layer and a second fibrous electrode layer by coating a cost-effective conductive polymer (e.g., poly(3,4-ethylenedioxythiophene) blended with polystyrene sulfonate) on fibrous layers such as the polyester fabric, wherein the second fibrous electrode layer is configured to have a hydrophilic second region by hydrophilic treatment; and
(b) laminating two fibrous electrode layers together with a porous nanofibrous membrane (e.g., Nylon 6,6, polyacrylonitrile, etc.) and optionally at least two porous adhesive layers (by, for example, porous fusible interlinings), wherein the porous nanofibrous membrane is disposed between the two fibrous electrodes, and the two porous adhesive layers are disposed respectively between the first fibrous electrode layer and the porous nanofibrous membrane and between the second fibrous electrode layer and the porous nanofibrous membrane.

In certain embodiments, the method further comprises step (c): incorporating a portable battery unit or power supply into the system.

In certain embodiments, the porous nanofibrous membrane has a pore size in submicron scale (e.g., a pore size of about 0.45 µm). In certain embodiments, the porous nanofibrous membrane may be a moderately hydrophilic Nylon 6,6 or a highly hydrophilic polyacrylonitrile (PAN), such as a nanofiber Nylon 6,6 membrane with submicron scale pore size. In certain embodiments, the first and second fibrous electrode layers may be composed of the following electrode materials: carbon fibers, carbon nanotubes, graphene, metals, or any combination thereof.

### 11. Method for Preparing Controllable Liquid Transport Material Comprising Channels Throughout the Material in the Second Region

Certain embodiments of the present invention provide a method of preparing the controllable liquid transport material described according to certain embodiments of Section 6 above of the present invention, the method comprising:
(a) dipping a substrate for preparing the controllable liquid transport material with D4;
(b) covering both sides of the material obtained in step (a) with two 3D printing molds each having a plurality of controllable patterns (wherein the controllable patterns cover the second region while the first region is not covered) for subsequent plasma treatment to induce D4 polymerization; and
(c) removing the mold on one side of the material and performing plasma treatment to initiate D4 polymerization.

### 12. Method for Preparing Controllable Liquid Transport Material With Varied or Gradient Wettability Between the First and Second Surfaces of the Second Region

Certain embodiments of the present invention also provide a method of preparing the controllable liquid transport material described according to certain embodiments of Section 3 above of the present invention, the method comprising preparing the controllable liquid transport material with hydrophilic yarns (or fibers) and hydrophobic yarns (or fibers) using a plating method in knitting technology, wherein the hydrophobic yarns (or fibers) are woven into a first layer and the hydrophilic yarns (or fibers) are woven into a second layer, and then the first region of the hydrophilic second layer is treated to be hydrophobic (or alternatively, the second layer as a whole may also be treated to be hydrophobic, and then the second region is subjected to a hydrophilic treatment, wherein the magnitude of wettability of the second region can be controlled, for example, by controlling the scanning rate or treatment time length of the plasma.

In other embodiments, the method comprises preparing the controllable liquid transport material of the present aspect by employing hydrophobic yarns (or fibers) and yarns (or fibers) with periodic hydrophobic segments and hydrophilic segments using a plating method in knitting technology, wherein the hydrophobic yarns (or fibers) are woven into a first layer; and the yarns (or fibers) with periodic hydrophobic segments and hydrophilic segments are woven into a second layer. Optionally, the wettability of the second region in thickness is adjusted by adjusting the arrangement density and/or size of the fibers or yarns.

### 13. Method for Preparing Controllable Liquid Transport Articles

Certain embodiments of the present invention also provide a method of preparing the controllable liquid transport article described in certain embodiments of Section 7 above, the method comprising laminating together the inner layer, the outer layer, and a middle layer as spacing layer disposed between the outer layer and the inner layer, and optionally at least two porous adhesive layers disposed on both sides of the spacing layer.

In certain embodiments, the method further comprises disposing a wearable fan at the spacing layer. In certain embodiments, the method further comprises using a sealing layer for sealing the edges of the inner layer, the middle layer, the outer layer, and optionally the porous adhesive layer, such that the sealing layer facilitates collecting accumulated liquid in the system or preventing the accumulated liquid from falling directly to the ground when the article is used.

In certain embodiments, the spacing layer may be a 3D printing layer, a molding layer, or may be composed of a weft knit fabric, a warp knit fabric, or a woven fabric.

### 14. Controllable Liquid Transport Material or System Prepared by the Method of The Present Invention

Certain embodiments of the present invention provide a controllable liquid transport material or system prepared by the method described in any of the embodiments in Sections 8-13 above.

### 15. Article

Certain embodiments of the present invention also provide an article made of the controllable liquid transport material, article or system described in any of the embodiments of Sections 2-7 and 14 herein.

In certain embodiments, the article includes, but are not limited to, a towel, a handkerchief, a sports guard, a bedding, a sportswear garment, a casual outerwear, a firefighter protective clothing, a winter jacket, a protective fabric, an insulation garment, a military garment, an industrial workwear garment, an oil/water separator, a wound dressing, a construction material, a tent, a mask, a respirator, a seawater demineralizer or a microfluidic device.

In certain embodiments of the sections described above, the shapes of the channels may be Z-shape, trapezoidal, or conical, and the like. In certain embodiments, the channels are Z-shaped or deformed Z-shaped, wherein optionally the deformed Z shape is configured such that an angle between two (upper and lower) short-transverse lines and the connecting line between them is a right angle or an obtuse angle.

In certain embodiments of various sections described hereinabove, the liquid delivered by the material or system of the present invention is sweat. When the present invention is used to prepare a garment, the first surface described in the above aspects of the present invention is a surface more proximal to the skin as compared to the second surface, unless otherwise indicated.

In certain embodiments of the sections described above, the wettability from the first surface to the second surface of the second region; and/or the controllable liquid transport material comprises a plurality of second regions and the plurality of second regions are partially contacted or completely separated. In certain embodiments, the second region connects the first region.

In certain embodiments of the sections described above, the first surface area is optionally greater than the second surface area.

In certain embodiments of the sections described above, when the area defining the first surface and/or the second surface is at least 1 mm², the area of the first surface and/or the second surface may also be selected from the group consisting of: about 1-9000 mm², 1-8000 mm², 1-7000 mm², 1-6000 mm², 1-5000 mm², 1-4000 mm², 1-3000 mm², 1-2000 mm², 1-1000 mm², 1-900 mm², 1-800 mm², 1-700 mm², 1-600 mm², 1-500 mm², 1-400 mm², 1-300 mm², 1-200 mm², preferably 10-100 mm², e.g., 10-95 mm², 10-90 mm², 10-85 mm², 10-80 mm², 10-75 mm², 10-70 mm², 10-65 mm², 10-60 mm², 10-55 mm², 10-50 mm², 15-100 mm², 15-90 mm², 15-80 mm², 15-70 mm², 15-60 mm², 15-50 mm², 20-100 mm², 20-90 mm², 20-80 mm², 20-70 mm², 20-60 mm², 20-50 mm², 25-100 mm², 25-90 mm², 25-80 mm², 25-70 mm², 25-60 mm², 25-50 mm², 30-100 mm², 30-90 mm², 30-80 mm², 30-70 mm², 30-60 mm², 30-50 mm², 35-100 mm², 35-90 mm², 35-80 mm², 35-70 mm², 35-60 mm², 35-50 mm², 40-70 mm², 45-75 mm², and the like, and any point values and sub-ranges thereof. In certain embodiments, the first and/or second surface area is about 10-400 mm².

In certain embodiments of the sections described above, the first pore size is about 0.2-7000 µm, 0.2-6000 µm, 0.2-5000 µm, 0.2-4000 µm, 0.2-3000 µm, 0.2-2000 µm, 0.2-1000 µm, 5.0-7000 µm, 5.0-6000 µm, 5.0-5000 µm, 5.0-4000 µm, 5.0-3000 µm, 5.0-2000 µm, 5.0-1000 µm, 10-7000 µm, 10-6000 µm, 10-5000 µm, 10-4000 µm, 10-3000 µm, 10-2000 µm, 10-1000 µm, 10-900 µm, 10-800 µm, 10-700 µm, 10-600 µm, 10-500 µm, 10-400 µm, preferably about 10-300 µm, e.g., about 10-250 µm, 10-200 µm, 10-180 µm, 10-150 µm, 10-120 µm, 10-100 µm, 15-300 µm, 15-280 µm, 15-250 µm, 15-220 µm, 15-200 µm, 20-270 µm, 20-240 µm, 20-200 µm, 20-170 µm, 20-140 µm, 25-300 µm, 30-300 µm, 35-300 µm, 40-300 µm, 45-300 µm, 50-300 µm, 55-300 µm, 60-300 µm, 65-300 µm, 70-300 µm, 75-300 µm, 80-300 µm, 85-300 µm, 90-300 µm, 95-300 µm, 100-300 µm, 110-300 µm, 130-300 µm and the like and any point values and subranges therein.

In certain embodiments of the sections described above, the second pore size is about 0.1-1500 µm, 0.1-1000 µm, 0.1-800 µm, 0.1-600 µm, 0.1-400 µm, 0.1-200 µm, 0.1-100 µm, 5.0-1500 µm, 5.0-1000 µm, 5.0-800 µm, 5.0-600 µm, 5.0-400 µm, 5.0-200 µm, 5.0-100 µm, 10-1500 µm, 10-1000 µm, 10-800 µm, 10-600 µm, 10-400 µm, 10-200 µm, 10-100 µm, e.g., 5-300 µm, 5-150 µm, 10-300 µm, 15-290 µm, 20-285 µm, 25-280 µm, 30-275 µm, 35-270 µm, 40-265 µm, 45-260 µm, 50-255 µm, 55-250 µm, 60-245 µm, 65-240 µm, 70-235 µm, 75-230 µm, 80-225 µm, 85-220 µm, 90-215 µm, 95-210 µm, 95-200 µm, 100-180 µm, 110-150 µm, 120-140 µm, 10-150 µm, 20-140 µm, 30-130 µm, 40-120 µm, 50-110 µm, 60-100 µm, 70-90 µm, 35-95 µm and the like and any point values and subranges therein.

In certain embodiments of the sections described above, the ratio of the second pore size to the first pore size is less than about 1:2, such as about 1:2.5, 1:3, 1:3.5, 1:4, 1:4.5, 1:5, 1:6, 1:6.5, 1:7, 1:8, 1:9, 1:10, or even less, and any point values and subranges therein.

In certain embodiments of the sections described above, the ratio of the total area of the first region to the total area of the second region is about 1/15-5000. In certain embodiments, the area ratio is about 1/15-4500, about 1/15-4000, about ⅒-3500, about ⅒-3000, about ⅕-2500, about ⅕-2000, about 1-1500, about 1-1000, about 10-900, about 10-800, about 10-700, about 20-600, about 20-550, about 20-500, about 20-450, about 20-400, about 30-350, about 30-300, about 40-250, about 40-200, about 50-150, about 50-100, about 100-500, about 100-600, about 100-700, about 100-800, about 200-500, about 200-600, about 200-700, about 200-800, about 300-500, about 300-600, about 300-700, about 300-800, about 300-900, about 400-600, about 400-800, about 400-1000, and any point values or subranges therein.

In certain embodiments of the sections described above, the first region is preferably continuously distributed. Alternatively, the first region may be spaced apart by the second region.

In certain embodiments of the sections described above, the yarns may be made from cotton, wool, hemp, silk, synthetic fibers (e.g., Terylene, chinlon, Acrylon, polyvinyl chloride fiber, Nylon, etc.), or any combination thereof. Alternatively, the fibers may be cotton fibers, wool fibers, hemp fibers, silk fibers, synthetic fibers (e.g., Terylene, chinlon, Acrylon, polyvinyl chloride fiber, Nylon, etc.), and the like, or any combination thereof.

In certain embodiments of the sections described above, the controllable liquid transport material or the substrate from which the controllable liquid transport material is prepared is made from a natural material and/or synthetic material. In certain embodiments, the natural material is selected from the group consisting of cotton, wool, silk, flax, bamboo fiber, or any combination thereof. In still other embodiments, the synthetic material is selected from the group consisting of: Teflon, polypropylene fiber, Terylene, chinlon, Acrylon, Spandex, Nylon, or any combination thereof.

In certain embodiments of the sections described above, the hydrophilic treatment or the hydrophobic treatment includes, but is not limited to: plasma modification method, UV modification, plasma etching method, chemical etching method, solution infiltration method, chemical deposition method, laser electrodeposition method, template deposition method, nanoparticle deposition method.

In certain embodiments of the sections described above, the first region is hydrophobic itself or rendered hydrophobic by a hydrophobic treatment. In certain embodiments, the hydrophobic treatment includes initiating polymerization with octamethylcyclotetrasiloxane (D4) plasma to generate hydrophobicity, or spraying hydrophobic solution such as TiO₂ solution to generate hydrophobicity, or depositing 1H,1H,2H,2H-perfluorooctyltrichlorosilane (POTS) on the surface of materials by chemical deposition to generate hydrophobicity.

In certain embodiments of the sections described above, the second region may be any shape, preferably having a shape selected from rectangle, triangle, oval, diamond, circle, square, Y-shape, +-shape, tree-shape, web-shape, Z-shape, or variations thereof, or any combination thereof.

The advantages provided by the present invention include one or more of the following: controllable liquid transport; neither too heavy nor too clingy; still breathable when wet; repelling and blocking external liquids and keeping it breathable; a more controllable liquid transport when connected to powering units.

The scope of the invention is not limited to any of the specific embodiments described herein. The following examples are provided for illustration only.

### Example 1a

### Controllable Liquid Transport Fabric With Varied Wettabilities in the Second Region of Different Shapes

Controllable liquid transport fabric was prepared by a two-step plasma treatment (FIG. 2). Step 1): the hydrophobicity of the cotton fabric was prepared by plasma inducing polymerization of octamethylcyclotetrasiloxane (D4); Step 2): the localized regions (e.g., the second regions) with varied or gradient wettability across the thickness was constructed by plasma-etching the hydrophobic fabric covered by masks having controllable patterns and shapes, such as rectangle, triangle, oval, diamond, circle, square, Y-shape, +-shape, tree-shape, web-shape, Z-shape, etc. In step 2) varied or gradient wettability was generated from hydrophilicity at the exposed side (i.e., the surface of the created localized region) to hydrophobicity at the unexposed side (i.e., the other surface of the created localized region), resulting from different degrees of plasma etching (to enhance hydrophilicity) through the thickness of the fabric.

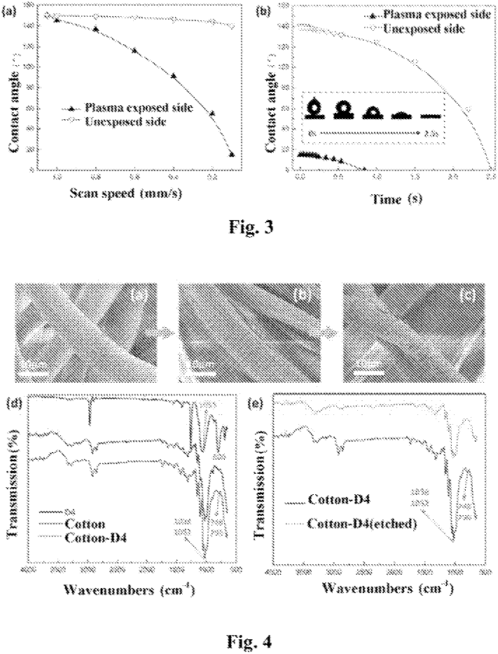

The water contact angle of the hydrophobic fabric from Step 1 was around 150°. The plasma etching in Step 2 was applied to modify wettability in localized regions with different shapes. During etching in Step 2, the plasma scan speed varied from 1 to 0.1 mm/s, resulting in different wettability. When a water droplet of 5µL was placed on the etched hydrophobic fabrics, the corresponding contact angles (CA) on the exposed side and unexposed side changed with different plasma scan speeds (FIG. 3a). With increasing etching time or decreasing scan speed, the contact angle on the exposed side decreased significantly, but decreased only slightly on the unexposed side due to the limited exposure to the plasma. Under a given plasma scan speed of 0.1 mm/s, the water contact angle on the exposed fabric surface was 15° and became 0 within 0.84 s, and a slight decline in contact angle was found on the unexposed surface varying from 150° to 140° in 2.5 s. Directional water transport was obtained with different plasma scan speeds of 0.3 mm/s, 0.2 mm/s and 0.1 mm/s, and the complete absorption of the liquid droplets from one side of the fabric to the opposite side took 23.2 s, 8.2 s, and 2.5 s, respectively (FIG. 3b).

The surface morphology of fabrics treated with plasma etching (in Step 2) was characterized by SEM (FIGS. 4a, 4b, and 4c). In comparison to the side (i.e., the surface) exposed to plasma etching, the unexposed side remained hydrophilic after plasma treatment. The chemical compositions of the D4, the cotton fabric, and the D4 treated cotton fabric were characterized by FTIR (FIGS. 4d and 4e). After plasma etching, the hydrophobic bonding was broken and the hydrophobicity reduced with increasing plasma etching, consistent with the changes of contact angle in FIG. 3.

The inclined, controllable liquid transport fabric allowed the liquid water to spontaneously penetrate into the fabric from the skin side (the inner surface in contact with the skin) to the face side (the outer surface) and to cumulatively grow to larger liquid droplets that then rolled off along the outer surface of the fabric under the effect of gravity (FIG. 5). Moreover, external liquids like falling rain were repelled by the outer surface of the fabric, rolling off along the outer surface quickly (FIG. 5). It is apparent that the mode of sweat removal from the skin side to the outer surface of the fabric in the form of liquid droplets is much more effective than that by sweat evaporation on the fabric surface, as one liquid-phase droplet contains thousands of millions of gaseous-phase molecules.

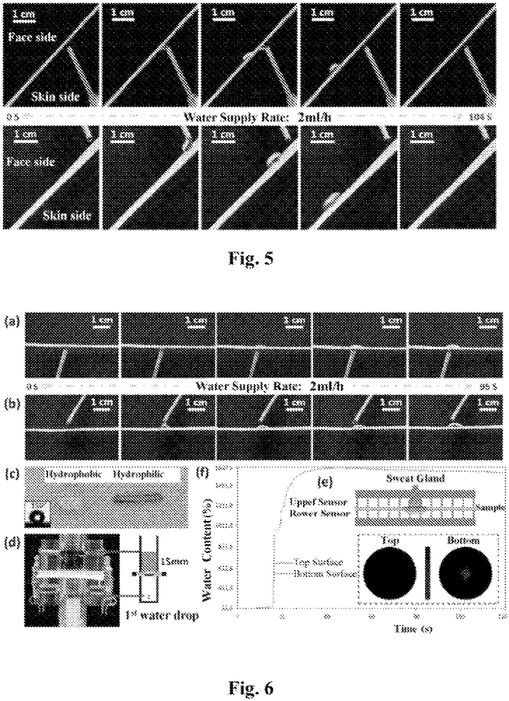

The horizontally disposed, controllable liquid transport fabric allowed the liquid water to spontaneously penetrate into the fabric from the skin side to the face side (i.e., the outer surface) and to cumulatively grow to liquid droplets in an anti-gravity mode (FIG. 6a). Besides, external liquids like falling rain were repelled by the outer surface of the fabric and could not penetrate into the fabric (FIG. 6b). Water droplets on the surface of the main hydrophobic region and the localized hydrophilic region (i.e., the first region and the second region) are shown in FIG. 6c. The breakthrough pressure of the liquid water was equivalent to a 15 mm high water column on the top of the fabric, indicating that the face side of the fabric possessed resistance to the penetration of external liquids (FIG. 6d).

Subsequently, the liquid transport across the controllable liquid transport fabric was characterized by the moisture management tester (MMT) (FIG. 6e). The skin side was placed upwards in the MMT, and salt-water droplets were supplied. The water content of the sample was measured over time. The results showed that the relative water content on the skin side (top surface) was close to zero (FIG. 6f, indicated by a straight line overlapping the abscissa), but the relative water content on the face side (bottom surface) of the controllable liquid transport fabric increased rapidly to 1647.9% in 40 s (FIG. 6f, indicated by the upper curve), which was much higher than the water contents in the untreated cotton fabric and the one-way transport fabric (with one side completely hydrophobic and the other completely hydrophilic) (Table 1). When the wearer sweats heavily, the untreated cotton fabric and the one-way transport fabric would be completely wet and saturated, with a slow liquid transport by sweat evaporation. In contrast, the present controllable liquid transport fabric could remove the excess liquid sweat efficiently from the skin side without increasing the weight.

Table 1. Relative water content on the bottom and top surfaces of different fabrics by MMT testing

| Fabric | Relative water content | |
|---|---|---|
| | Bottom surface | Top surface |
| Cotton | 40.3% | 284.8% |
| One-way transport fabric | 0 | 400.8% |
| Controllable liquid transport fabric | 0 | 1647.9% |

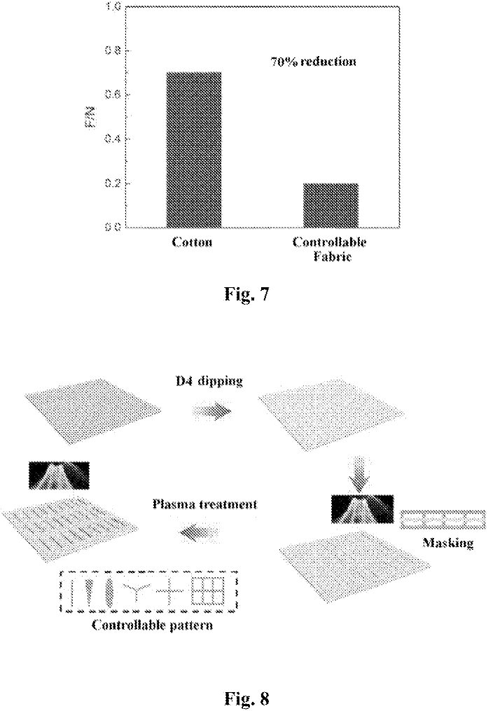

The controllable liquid transport fabric reduced the clingy effect in comparison with the untreated common cotton fabric (FIG. 7). Based on a fixed area (10*10 cm) of completely wet simulated skin, a measuring system consisting of an ergometer and a motor was used to measure the pulling force required to move the fabrics. The results showed a 70% reduction of the maximum pulling force required in the controllable liquid transport fabric compared to that in the untreated cotton fabric (FIG. 7).

### Example 1b

### Controllable Liquid Transport Fabric With Varied Wettability in Thickness of The Second Region With Different Shapes

An environmental-friendly, fluoride-free method is provided by the present example for preparation of the main hydrophobic region and the localized region with a gradient wettability in the controllable liquid transport fabric (i.e., the first and second regions, FIG. 8). This method works for both synthetic and natural fibers. Firstly, the fabrics was treated via conventional desizing, scouring, and bleaching processes prior to further processing. The cotton fabric selected (e.g., cotton fabric) was immersed in D4 monomer for 30 mins and dried at room temperature before plasma treatment. The degree of polymerization of the D4 monomer could be controlled by adjusting the plasma treatment time, resulting in the formation of a corresponding wettability gradient. Over a period of time, increasing exposure of the fabric to plasma led to increasing water repellence. Both sides of the fabric were covered and pressed by two 3D printed molds, by which the potential area of gradient wettability (i.e., the area that will become a localized region with wettability gradient) was compressed by controllable patterned bumps or raised areas with different shapes. The masked fabric was placed into a plasma system and treated under a certain power, for a given time (for example, treated in plasma under helium of a flow rate of 50 cc/min and a power of 120 W, for a given time). The plasma treatment created hydrophobicity in all unmasked areas. The 3D printed molds were then removed, exposing the fabric with one side covered by impermeable tape, and gradient wettability was formed due to the grafting polymerization of the D4 induced by plasma. With the plasma treatment, the desired gradient wettability was generated in localized regions across the patterned areas.

### Example 2

### Protective Fabric System for Controllable Liquid Transport and Collection

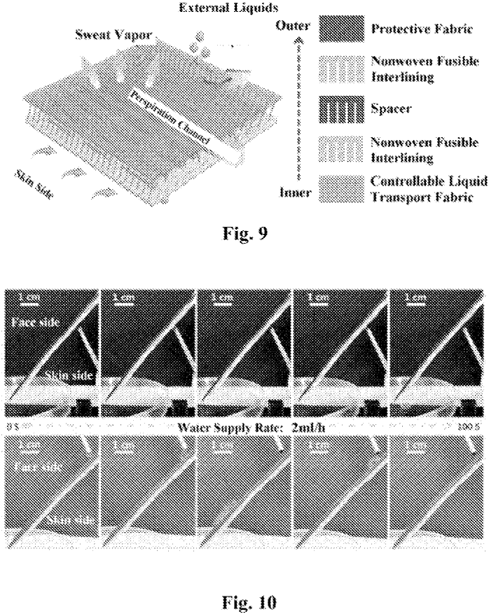

Controllable liquid transport fabric (e.g., the liquid transport fabric prepared in Examples 1a-1b) was integrated and laminated with a breathable, waterproof protective shell such as Gore-Tex to achieve both directional liquid transport and protective properties (FIG. 9). Laser-cut warp knitted spacers were used for the supporting and spacing layer between the shell and fabric to achieve hollow channels, directing the liquid transported from the skin side to the bottom area of the fabric system. The spacers could also bring more air ventilation into the microclimate close to the skin for improved thermal and moisture management. The spacing layer was treated to be hydrophobic. This multi-layered protective fabric system, made from an inner controllable liquid transport fabric layer, a middle spacing layer, and an outer shell layer, could be laminated by highly porous thin fusible nonwoven interlinings. The spacing layer could include weft knitted fabric, warp knitted fabric, woven fabric, 3D printing layer, molded layer, etc.

The liquid water spontaneously penetrated the fabric from the skin side upwards to the hollow channel and cumulatively formed liquid droplets in the middle layer between the fabric and the shell layers, thereby the droplets being released and rolling off through the channels towards the bottom of the fabric system under the effect of gravity (FIG. 10). On the other hand, water droplets from the outer face of the shell rolled off quickly along the shell outer face (FIG. 10). The breakthrough pressure from the face side to the skin side was over 6-m height of water column. Boundary areas of the protective fabric system could be sealed (FIG. 11), and the sweat liquid could be directed and collected for various applications such as real-time health monitoring. The boundaries of the fabric systems could also be sealed to prevent sweat liquid from falling off to the ground, which could result in sliding injury caused by slippery floor.

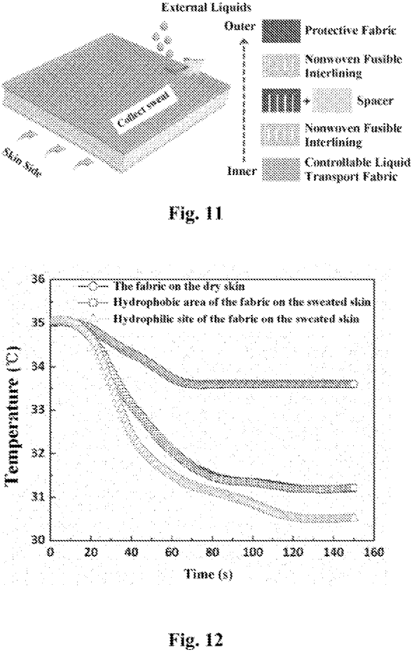

A wearable fan may be disposed in the middle-layer area to facilitate evaporative cooling, while a porous spacing layer allowed sufficient ventilation. The temperature of the skin side of the protective fabric (i.e., the face or layer that is in contact with the skin) was measured when the fan turned on or off (FIG. 12). As depicted in FIG. 12, the simulated skin of a hot plate was set to be at 35° C. with an environmental temperature of 25° C. When the fan turned on, the temperature of the skin side of the controlled, dry cotton fabric and the dry controllable liquid transport fabric was reduced to 33.6° C. However, the temperatures at the localized region and the surrounding hydrophobic region of the controllable liquid transport fabric were reduced to 30.5 and 31.2° C., respectively, indicating a promising cooling effect and thermal comfort.

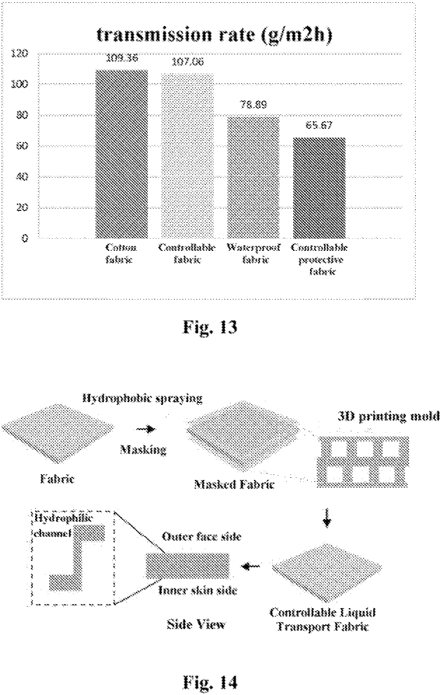

Water vapor transmission rate (breathability) tests according to GB/T 12704.2-2009 were performed on the protective fabric system (i.e., the structure prepared in the present example, as depicted in FIG. 9), the Gore-Tex waterproof shell, the controllable liquid transport cotton fabric (generated by the method of Example 1) and the untreated (i.e. not hydrophobically treated) cotton fabric, in which the values at 65.67 g/m²•h, 78.89 g/m²•h, 107.01 g/m²•h and 109.36 g/m²•h, were measured respectively (FIG. 13), indicating little difference between the original fabric substrates and the modified, controllable liquid transport fabric systems. Therefore, at the expense of slightly increased thickness, the protective fabric system with the allowance of perspiration and storage of sweat could keep the skin dry and resistant to external liquids without compromising breathability or comfort.

### Example 3

### Controllable Liquid Transport Fabric With Localized Hydrophilic Regions

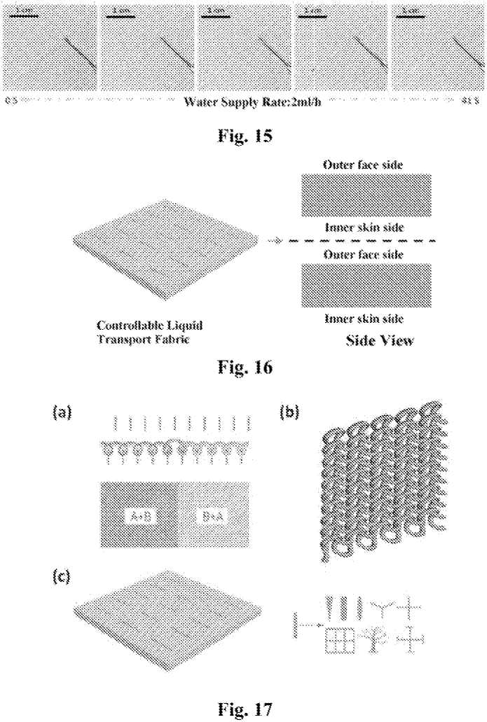

A fabric material in which the main region (i.e., the first region) is hydrophobic and the localized region (i.e., the second region) is a completely hydrophilic Z-shaped channel is provided by the present example, as shown in FIG. 14. The fabric was prepared by spraying hydrophobic TiO₂ solution on both sides (i.e., two surfaces), covered by 3D printing molds with a controllable pattern (FIG. 14). The area covered by the mold remained hydrophilic, and the middle region (i.e., there was a section of hydrophilic area on the first surface that ran through the second surface in the thickness direction to connect with the hydrophilic area of the second surface to form a hydrophilic channel) remained hydrophilic through both surfaces because of the very low exposure to hydrophobic sprays from both sides. The Z-shaped channel was all hydrophilic and connected the two asymmetrically faced sites on both surfaces of the fabric, permitting leading the liquid to transport from the inner site at a higher position to the outer site at a lower position, under the effects of gravity and capillary force. The areas surrounding the hydrophilic sites were hydrophobic, facilitating the formation of liquid droplets. The cumulatively growing liquid droplets eventually rolled off along the outer surface of the fabric (FIG. 15). This fabric could keep the wearer’s body skin relatively dry and comfortable despite heavy sweating. In addition, with careful hydrophilic treatment, the length of the hydrophilic channel in the middle area of the fabric could be programmably extended (FIG. 16), allowing long-distance transport of the liquid for various applications such as evaporative coolers and microfluidic devices.

### Example 4

### Woven Fabrics With Controllable Liquid Transport Properties

Fabric with the hydrophobic main regions (i.e., first regions) and the localized regions (i.e., second regions) having varied wettabilities across the thickness can be fabricated by existing fabric processing methods such as knitting (such as platedwork, intarsia, jacquard) etc. For example, knitted fabric with varied wettabilities can be fabricated by a plating method in knitting technology (FIG. 17a). In the weaving process, the loops formed by the top yarn and bottom yarn were knitted on different sides of the fabric in accordance with the pattern requirements (FIG. 17a). To realize the dual-layer structure with asymmetric wettabilities across the thickness of the fabric for directional water transport, hydrophilic and hydrophobic yarns were selected to weave the knitted fabric (FIG. 17b). The commercial yarns were treated to have a certain wettability (i.e., hydrophobicity) based on the methods described in Example 1. The knitted fabric could be treated with the main region to become hydrophilic and the localized region to become hydrophilic in the face surface (i.e., outer surface) (FIG. 17c) based on the D4 plasma modification method. Moreover, the yarns for the hydrophilic layer could be replaced by yarns with periodically distributed hydrophobic and hydrophilic segments, thereby directly fabricating the fabric with localized hydrophilicity without the need for subsequent treatment for gradient wettability. Thus, fabrics with the hydrophobic main regions and the localized regions of varied wettability in thickness could be fabricated from yarns with periodically varying wettability by weaving and knitting.

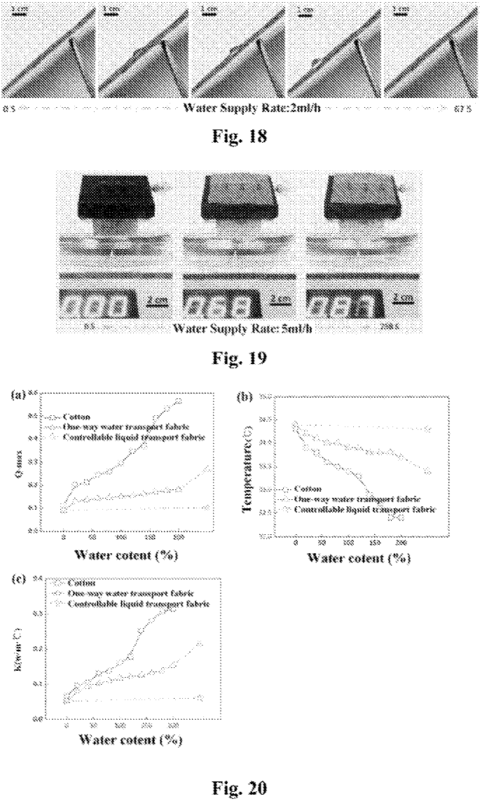

Based on the knitted fabric from FIG. 17b, the controllable liquid transport fabric was constructed by spraying hydrophobic TiO₂ solution on fabric with the localized region covered by a mask (FIG. 17c), allowing directional liquid transport from the inner side to the outer side and facilitating the cumulatively growing liquid droplets to roll off along the surface of the fabric under the influence of gravity (FIG. 18).

In order to evaluate the liquid transport capability of the knitted fabric, a customized simulated perspiration system was developed, which was made from a 3D printed box covered by simulated skin with tiny pores and a syringe pump (FIG. 19). Water droplets appeared on the simulated skin surface when liquid water was injected into the box. The controllable liquid transport woven fabric (5*5cm) was placed on the simulated skin with the water supply rate at 5ml/h. The weight of the fallen liquid droplets was recorded by an electronic scale.

The thermal conductivity of wet common fabrics was much higher than that of dry fabrics. However, the proposed controllable liquid transport woven fabric was mainly hydrophobic without absorbing too much liquid water, a feature that allows the fabric to remain dry and thermally insulated, thereby reducing the after-chilling effect. The values of instantaneous contact temperature-sensing standard (Q-max, for indicating chilling feel), thermal conductivity, and temperature among untreated cotton fabric (commercially available), knitted fabric (i.e., the fabric shown in FIG. 17b) with asymmetric wettabilities across the thickness, and controllable liquid transport woven fabric (prepared by Example 4) when contacting a given liquid source (to simulate sweat) are shown in FIG. 20. The controllable liquid transport woven fabric had the lowest Q-max value, indicating that the fabric had the minimum chilling feel when wet (FIG. 20a). The controllable liquid transport woven fabric had the lowest thermal conductivity (FIG. 20c) and the temperature remained constant (FIG. 20b: the curve shown for the controllable liquid transport fabric) under different liquid contents, providing a warmer sensation even in wet conditions.

### Example 5

### Woven Fabrics With Controllable Liquid Transport Properties and Fabric System Formed Therefrom

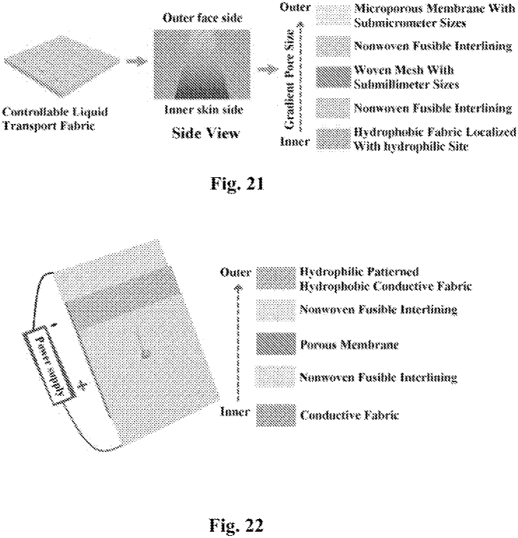

Fabrics with the main region (i.e., first region) hydrophobic and the localized regions (i.e., second regions) having various pore sizes can be fabricated by conventional fabric processing methods such as knitting (such as platedwork, intarsia, jacquard), weaving, stitching and embroidery, etc. For example, woven fabrics having various pore sizes across the thickness can be fabricated by a plating method in knitting technology (FIG. 21). In the weaving process, the loops formed by the top yarn and the bottom yarn were knitted on different sides of the fabric with yarns of different thicknesses and by adjusting the yarn distribution density. Furthermore, the fabric could be treated to have gradient wettability in localized regions, based on the methods in Example 1.

As depicted in FIG. 21, a fabric system similar to that described in Example 2 can also be formed using the fabric prepared in this example. Specifically, the fabric system may include the controllable liquid transport woven fabric of this embodiment (as an inner layer), a microporous membrane having submicron scale pore sizes (as an outer layer), and a woven mesh having submicron scale pore sizes (as a middle layer) disposed between the outer layer and the inner layer, wherein the pore size on each layer of material gradually decreased from the inner layer to the outer layer. Furthermore, two nonwoven fusible interlinings may be respectively disposed between a middle layer and an outer layer and between a middle layer and an inner layer, so that the inner layer, the middle layer and the outer layer were bonded together. Further, it is also possible to seal the edges of the afore-mentioned layers such that when in use, the system can be for collecting liquid or preventing liquid from falling off directly to the ground.

### Example 6

### Controllable Liquid Transport System With Electrically Driven Liquid Movement In Localized Regions

There is provided a typical controllable liquid transport fabric in which the movement of the liquid is driven by an electric potential in localized regions (i.e., the second regions), as depicted in FIG. 22. A nanofibrous Nylon 6,6 membrane with submicron scale pore sizes was laminated by two layers of fibrous electrodes, using loose, porous fusible interlinings. The electrodes were made by coating a cost-effective conductive polymer poly(3,4-ethylenedioxythiophene) blended with polystyrene sulfonate (PEDOT:PSS) on fibrous layers such as the polyester fabric, which could undergo electrochemistry without harmful byproducts. The polyester fabric was immersed in the solution of PEDOT:PSS dispersion with the second dopant, glycerol, for at least 36 h at room temperature. The fabric was then dried to remove excess solution and annealed to evaporate dopants.

Potential materials for nanofibrous membranes include moderately hydrophilic Nylon 6,6 and highly hydrophilic Polyacrylonitrile (PAN). The hydrophilicity was needed to allow capillary filling in the nanofibrous membrane for generating electroosmotic flow. The fabric could be integrated with a portable battery unit or power supply, connecting the two electrodes to the power by fine cables. A microcontroller based DC-DC converter could also be attached to a portable power bank for providing voltage, increasing portability and reducing the weight. The on-off mode was quickly switched and the value of voltage was easily adjusted for programming the working time. The fabric was treated following the methods used in Example 1 to make its surface hydrophobic. However, the outer surface could be hydrophilic or moderately hydrophobic, where the liquid could be removed by electroosmotic force.

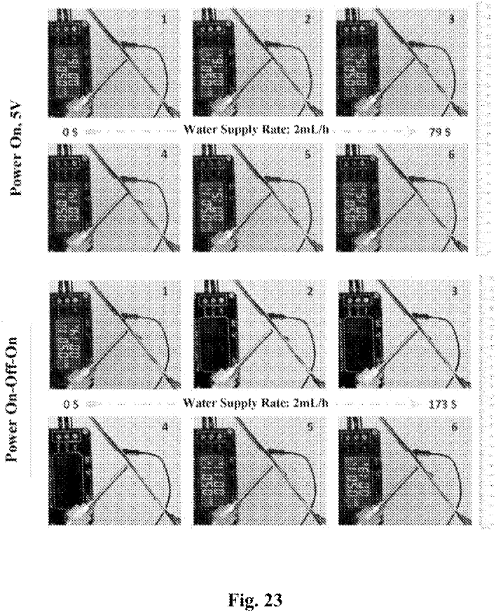

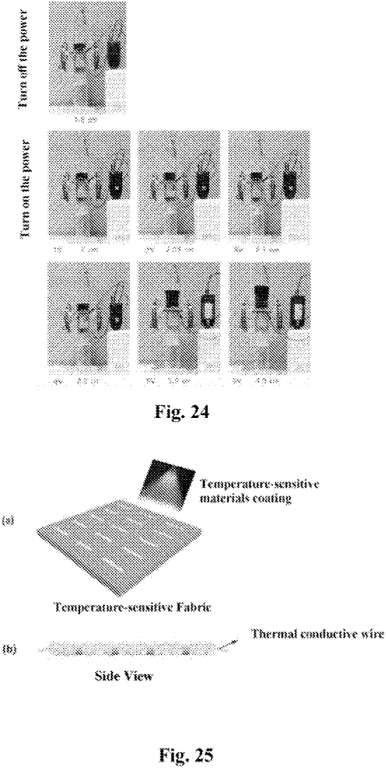

Under an applied voltage at 5V, the liquid water continuously moved from the inner side to the outer side under the Coulomb force induced by the electric field, in addition to the capillary force (FIG. 23). When the power was off, the water droplet being pushed out of the fabric moved back into the fabric and was absorbed by it again (FIG. 23). When the voltage was positive, the liquid from the outer side could not penetrate into the fabric unless it was at the breakthrough pressure of certain height of water column: e.g., 4.9 cm at 6 V (FIG. 24).

The inner and outer layers of electrodes could also be carbon cloth, which could be treated as hydrophilic and hydrophobic, respectively, within the localized regions. The middle layer could be nylon membrane with a pore size of 0.45 µm, and the highly porous, thin fusible nonwoven interlinings were used to fuse the layers together.

### Example 7

### Controllable Liquid Transport Fabric for Driving Liquid Movement by Adjusting Temperature in Localized Regions

One of the external stimuli can also be temperature. Temperature-sensitive materials such as hydrogel with hydrophobicity at lower temperatures and hydrophilicity at higher temperatures could be coated externally in localized regions (i.e., the second regions). The fabric remains hydrophobic on both sides at a given temperature (e.g. with the lower critical solution temperature equal to 35° C.), being repellent to external liquids; when the body temperature increased to above 35° C. due to activities such as sports activities or increasing ambient temperature, the outer side became hydrophilic, facilitating a directional, controllable liquid transport through the channels. To actively control the liquid transport, the wettability can be changed by heating the fabric, using an inserted thermally conductive wire coated with conductive coating, or integrated with a heat pad (FIG. 25).

### Example 8

### Controllable Liquid Transport Fabric for Driving Liquid Movement by Adjusting Ultrasonic Oscillation in Localized Regions

The ultrasonic humidifier employs high-frequency oscillation to expel water off the water surface through the high-frequency resonance of the atomizing sheet to generate a naturally floating water mist. A controllable liquid transport fabric in which the movement of the liquid is driven by ultrasonic high-frequency oscillation in localized regions is provided in this example, using the principle of the ultrasonic humidifier to secure the porous atomizing sheet to the outer surface of the fabric, as depicted in FIG. 27. The diameter of the atomizing sheet was 20±5 mm; the pore size was 5±1 µm; and the number of pores was 985±245. When the fabric wetted by human sweat contacted the atomizing sheet, a high-frequency oscillation of 108±5 KHZ was supplied under a condition of 5 V electric potential, and the sweat in the fabric was atomized into smaller liquid particles through the high-frequency resonance of the atomizing sheet and expelled into the air to volatilize naturally and quickly, thereby driving the controllable transport of liquid. In order to maximize the atomizing effect of the atomizing sheet, the fabric was designed as a localized tree-shaped drainage structure with directional liquid transport properties (the methods in Example 1, 3, 4 or 5 could be adopted) in this embodiment to accumulate sweat by drainage for atomization. The atomization rate of a single atomizing sheet was 30-60 g/h, and the penetration water pressure was equivalent to a water column with a height of 17 cm, showing an extremely high water transport unidirectionality. Damage of the atomizing sheet by salts in the sweat could be alleviated by adding a salt filter membrane on the inner side of the atomizing sheet.

The fabric could be incorporated with a portable battery unit or power supply, connecting the two electrodes to the power by fine cables. A microcontroller based DC-DC converter could also be attached to a portable power bank for providing voltage, increasing portability and reducing the weight. The on-off mode was quickly switched and the value of voltage was easily adjusted for programming the working time.

In addition, the ultrasonic oscillation atomizing system can be combined with any one or more of the controllable liquid transport fabric with varied wettabilities across the thickness of the second regions having different shapes, the controllable liquid transport fabric with the second regions having localized hydrophilicity, the woven fabric with the controllable liquid transport properties, or the controllable liquid transport system with electrically driven liquid movement in the second regions, in order to increase the liquid transport efficiency thereof.

The above descriptions of the examples are for the convenience of those of ordinary skill in the art to understand and apply the invention. It will be apparent to those skilled in the art that various modifications may be readily made to these examples and that the general principles described herein may be applied to other examples without creative work. Therefore, the present invention is not limited to the specific examples disclosed herein, and improvements and modifications made by those skilled in the art according to the principles of the present invention without departing from the scope of the present invention should be within the protection scope of the present invention.

### REFERENCES

Jessen, Claus. Temperature regulation in humans and other mammals. Springer Science & Business Media, 2012.

Mack, Gary W., and Ethan R. Nadel. Body fluid balance during heat stress in humans. Comprehensive Physiology (2010): 187-214.

Sawka, Michael N., C. Bruce Wenger, and Kent B. Pandolf. Thermoregulatory responses to acute exercise-heat stress and heat acclimation. Comprehensive physiology (2010): 157-185.

F. Wang, X. Zhou, S. Wang, Development processes and property measurements of moisture absorption and quick dry fabrics, Fibers & Textiles in Eastern Europe, 17 (2009) 46-49.

B. Dai, K. Li, L. Shi, X. Wan, X. Liu, F. Zhang, L. Jiang, S. Wang, Bioinspired Janus Textile with Conical Micropores for Human Body Moisture and Thermal Management, Advanced Materials, 31 (2019) 1904113.

Y. Wang, X. Liang, H. Zhu, J.H. Xin, Q. Zhang, S. Zhu, Reversible Water Transportation Diode: Temperature-Adaptive Smart Janus Textile for Moisture/Thermal Management, Advanced Functional Materials, 30 (2020) 1907851

Zhou, Hua, et al. Superphobicity/philicity janus fabrics with switchable, spontaneous, directional transport ability to water and oil fluids. Scientific reports 3 (2013): 2964.

Wang, Hongxia, et al. Directional water-transfer through fabrics induced by asymmetric wettability. Journal of Materials Chemistry 20.37 (2010): 7938-7940.

Wang, Hongxia, et al. Selective, spontaneous one-way oil-transport fabrics and their novel use for gauging liquid surface tension. ACS applied materials & interfaces 7.41 (2015): 22874-22880.

Wang, Jing-Jing, et al. Nanofiltration membranes with cellulose nanocrystals as an interlayer for unprecedented performance. Journal of Materials Chemistry A 5.31 (2017): 16289-16295.

Xu, Zhiguang, et al. Fluorine-free superhydrophobic coatings with pH-induced wettability transition for controllable oil-water separation. ACS applied materials & interfaces 8.8 (2016): 5661-5667.

X. Wang, Z. Huang, D. Miao, J. Zhao, J. Yu, B. Ding, Biomimetic fibrous murray membranes with ultrafast water transport and evaporation for smart moisture-wicking fabrics, ACS nano, 13 (2018) 1060-1070.

Wu, Jing, et al. Unidirectional water-penetration composite fibrous film via electrospinning. Soft Matter 8.22 (2012): 5996-5999.

Wang, Hongxia, et al. Dual-layer superamphiphobic/superhydrophobic-oleophilic nanofibrous membranes with unidirectional oil-transport ability and strengthened oil-water separation performance. Advanced Materials Interfaces 2.4 (2015): 1400506.

Shi, Yongli, et al. A novel transdermal drug delivery system based on self-adhesive Janus nanofibrous film with high breathability and monodirectional water-penetration. Journal of Biomaterials Science, Polymer Edition 25.7 (2014): 713-728.

Dong, Yuliang, et al. Tailoring surface hydrophilicity of porous electrospun nanofibers to enhance capillary and push-pull effects for moisture wicking. ACS applied materials & interfaces 6.16 (2014): 14087-14095.

J.T. Fan, M.K. Sarkar, Y.C. Szeto, X.M. Tao, Plant structured textile fabrics, Materials Letters, 61 (2007) 561-565.

Q. Chen, J.T. Fan, M.K. Sarkar, Biomimetics of branching structure in warp knitted fabrics to improve water transport properties for comfort, Textile Research Journal, 82 (2012) 1131-1142.

D. Shou, L. Ye, J. Fan, Treelike networks accelerating capillary flow, Physical Review E, 89 (2014) 053007.

D. Shou, L. Ye, F. Fan, K. Fu, M. Mei, H. Wang, Q. Chen, Geometry-induced asymmetric capillary flow, Langmuir 30 (2014) 5448-5454.

D. Shou, L. Ye, J. Fan, K. Fu, Optimal Design of Porous Structures for the Fastest Liquid Absorption, Langmuir, 30 (2014) 149-155.

D.H. Shou, J.T. Fan, The fastest capillary penetration of power-law fluids, Chemical Engineering Science, 137 (2015) 583-589.

D. Shou, J. Fan, An All Hydrophilic Fluid Diode for Unidirectional Flow in Porous Systems, Advanced Functional Materials, 28 (2018) 1800269.

Lao, L., et al. “Skin-like” fabric for personal moisture management. Science advances 6.14 (2020): eaaz0013

Although the invention has been described in terms of certain embodiments, other embodiments apparent to those of ordinary skill in the art are also within the scope of this invention. Accordingly, the scope of the invention is intended to be defined only by the claims which follow.

1. A controllable liquid transport material comprising a hydrophobic first region and one or more second regions, wherein each of the second regions comprises a first surface and a second surface, wherein:
the first surface has a wettability smaller than that of the second surface; and
the first surface has an area of at least 1 mm²; and/or the second surface has an area of at least 1 mm³.

2. The controllable liquid transport material of claim 1, being obtained by one or more of the following methods:
(a) obtaining the material having the first region and the second region by subjecting a hydrophobic material to a hydrophilic treatment, wherein the first surface of the second region is configured to have a smaller wettability than that of the second surface and/or the area of the first and/or second surface is/are obtained by controlling the hydrophilic treatment;
(b) obtaining the material having the first region and the second region by subjecting hydrophilic materials to a hydrophobic treatment and a hydrophilic treatment, respectively, wherein the first surface of the second region is configured to have a smaller wettability than that of the second surface thereof and/or the area of the first and/or second surface is/are obtained by controlling the hydrophilic treatment;
(c) weaving yarns having periodically distributed hydrophobic and hydrophilic segments to obtain the controllable liquid transport material by a method comprising knitting, weaving, stitching or embroidering, such that the first region is formed from the hydrophobic segments and the second region is formed from the hydrophilic segments, wherein the first surface of the second region is configured to have a smaller wettability than that of the second surface thereof and/or the area of the first and/or second surface is/are obtained by adjusting distribution density and/or yarn size of the yarns; or
(d) weaving hydrophobic and hydrophilic yarns to obtain the controllable liquid transport material by a method comprising knitting, weaving, stitching or embroidering, such that the first region is formed from the hydrophobic yarns and the second region is formed from the hydrophilic yarns, wherein the first surface of the second region is configured to have a smaller wettability than that of the second surface and/or the area of the first and/or second surface is/are obtained by adjusting distribution density and/or yarn size of the yarns.

3. The controllable liquid transport material of claim 2, wherein the material comprises first and second layers arranged adjacent to each other, wherein the first layer is hydrophobic, and the second layer comprises the hydrophobic first region and the one or more second regions.

4. The controllable liquid transport material of claim 3, wherein the first layer is formed from hydrophobic yarns and the second layer is formed by one or more of the methods (a)-(d).

5. The controllable liquid transport material of claim 3, wherein:
the controllable liquid transport material is formed from hydrophilic and hydrophobic yarns by weaving using plating, such that the hydrophobic yarns constitute the first layer and the hydrophilic yarns constitute the second layer, wherein the second layer has the first region and the second region by hydrophobic treatment and hydrophilic treatment, respectively; or
the controllable liquid transport material is formed from hydrophobic yarns and yarns having periodically distributed hydrophobic and hydrophilic segments by weaving using plating, such that the hydrophobic yarns constitute the first layer and the yarns having periodically distributed hydrophobic and hydrophilic segments constitute the second layer.

6. The controllable liquid transport material of claim 1, wherein the wettability from the first surface to the second surface varies in gradient; and/or
the controllable liquid transport material comprises a plurality of second regions and the plurality of second regions are partially contacted or completely separated.

7. A controllable liquid transport material comprising a hydrophobic first region and one or more second regions, wherein the second region comprises a first surface and a second surface, wherein:
the second region comprises a smart material configured to directionally transport liquid from the first surface to the second surface when required.

8. The controllable liquid transport material of claim 7, wherein the smart material is a temperature-sensitive material coated on the second surface, such that the second surface changes from a hydrophobic surface to a hydrophilic surface when an ambient temperature reaches a threshold temperature, allowing a directional transport of liquid from the first surface to the second surface.

9. The controllable liquid transport material of claim 8, wherein the material is further provided with a thermally conductive wire in contact with the second region, the thermally conductive wire being an electrical wire or coated thereon with an electrically conductive coating or integrated with a temperature-sensitive element, thereby heating the temperature-sensitive material to become hydrophilic when a power is on.

10. The controllable liquid transport material of claim 7, wherein the second region is hydrophilic, and the first surface and the second surface are provided with a first electrode and a second electrode, respectively, and the liquid is directed to flow from the first surface to the second surface when the first electrode is connected to a negative electrode of a power supply and the second electrode is connected to a positive electrode of the power supply.

11. The controllable liquid transport material of claim 7, wherein the second region is hydrophilic, and the second surface is attached with an ultrasonic oscillating atomizing sheet configured to release liquid transported to the second surface to air when the first surface transports the liquid to the second surface, causing the liquid to continuously flow from the first surface to the second surface.

12. A controllable liquid transport material comprising a hydrophobic first region and one or more second regions, wherein the second region has a first surface and a second surface,
wherein the second region comprises channels through the controllable liquid transport material and is hydrophilic, the channels defining a first position, a first surface area, and/or a first pore size on the first surface, and the channels also defining a second position, a second surface area, and/or a second pore size on the second surface, wherein:
(1) in use, the first position is higher than the second position or the first position is equal or substantially equal in height to the second position; and/or (2) the first pore size is greater than the second pore size.

13. The controllable liquid transport material of claim 12, wherein the first surface area is at least 1 mm², and/or the second surface area is at least 1 mm²; or the first pore size is about 0.2-8000 µm, and/or the second pore size is about 0.1-2000 µm.

14. The controllable liquid transport material of claim 12, wherein in use, the first position is higher than the second position or the first position is equal or substantially equal in height to the second position, and the channels are Z-shaped, trapezoidal, conical, or deformed Z-shaped, wherein the deformed Z shape is configured such that an angle between two short-transverse lines corresponding to upper and lower transverse lines and a connecting line between the two short-transverse lines is a right angle or an obtuse angle.

15. The controllable liquid transport material of claim 12, wherein the controllable liquid transport material is woven by a weaving method, wherein the channels are made to have different pore sizes in thickness by adjusting the arrangement density of the yarns and/or the yarn size, and wherein the yarns forming the channels are hydrophilic or treated to be hydrophilic.

16. The controllable liquid transport material of claim 12, wherein the controllable liquid transport material comprises a plurality of second regions and the plurality of second regions are partially contacted or completely separated.

17. A controllable liquid transport system comprising a first fibrous electrode layer as an inner layer, a second fibrous electrode layer as an outer layer, a porous nanofibrous membrane layer disposed between the inner and outer layers as a middle layer, and optionally at least two porous adhesive layers disposed on both sides of the middle layer,
wherein the second fibrous electrode layer comprises a first region and a hydrophilic second region, wherein the second region comprises a first surface and a second surface, and the middle layer has a submicron scale pore size.

18. The system of claim 17, wherein the fibrous electrode layer is prepared by coating a conductive polymer on the fibers, and the first fibrous electrode layer and the second fibrous electrode layer are composed of an electrode material selected from carbon fibers, carbon nanotubes, graphene, metals, or any combination thereof.

19. The system of claim 17, wherein the first surface has an area of at least 1 mm², and/or the second surface has an area of at least 1 mm²; and/or
wherein the second fibrous electrode layer comprises a plurality of second regions and the plurality of second regions are partially contacted or completely separated.

20. The controllable liquid transport material of claim 1, wherein the second region has a shape selected rectangle, triangle, oval, diamond, circle, square, Y-shape, +-shape, tree-shape, web-shape, Z-shape, or variations thereof, or any combination thereof.

21. The controllable liquid transport material of claim 1, wherein the controllable liquid transport material is made from a natural material and/or a synthetic material, wherein the natural material is selected from cotton, wool, silk, flax, bamboo fiber or any combination thereof; and/or the synthetic material is selected from Teflon, polypropylene fiber, Terylene, chinlon, Acrylon, Spandex, Nylon, or any combination thereof.

22. A controllable liquid transport article comprising an inner layer, an outer layer, a middle layer disposed between the outer layer and the inner layer, and optionally at least two porous adhesive layers disposed on both sides of the middle layer, wherein the inner layer is composed of the controllable liquid transport material of claim 1, the outer layer is composed of a breathable, waterproof material, and the middle layer is hydrophobic and provided with hollow channels thereon.

23. The article of claim 22, wherein the article further comprises a sealing layer at edges of the inner layer, the middle layer, the outer layer, and the porous adhesive layer, the sealing layer being configured to collect accumulated liquid in the article or prevent the accumulated liquid from falling from the article when the article is used.

24. An article composed of the controllable liquid transport material of claim 1, comprising a towel, a handkerchief, a sports guard, a bedding, a sportswear garment, a casual coat, a firefighter protective clothing, a winter jacket, a protective fabric, an insulation garment, a military garment, an industrial workwear garment, an oil/water separator, a wound dressing, a construction material, a tent, a mask, a respirator, a seawater demineralizer or a microfluidic device.
